(19) United States
(12) Patent Application Publication
(10) Pub. No.: US 2026/0309242 A1
(43) Pub. Date: Oct. 8, 2026

(54) MULTI-WAY SWITCHING VALVE DEVICE

(71) Applicant: MIKUNI CORPORATION, Tokyo (JP)

(72) Inventors: Yuichi KOIKE, Kanagawa (JP); Kazufumi YOSHIYA, Kanagawa (JP); Shoichi ISHIGUCHI, Kanagawa (JP); Tomonori KAKIZOE, Kanagawa (JP)

(73) Assignee: MIKUNI CORPORATION, Tokyo (JP)

(21) Appl. No.: 19/454,425

(22) Filed: Jan. 21, 2026

(30) Foreign Application Priority Data
Apr. 3, 2025 (JP) 2025-061902

(51) Int. Cl. F16K 11/085; F25B 41/20

(52) U.S. Cl. CPC F16K 11/0856; F25B 41/20; F25B 2313/02741

(57) ABSTRACT

A multi-way switching valve device includes: a base member defining a first inlet and a first outlet of a first fluid passage, a second inlet and a second outlet of a second fluid passage, a third inlet and a third outlet of a third fluid passage, and a fourth inlet and a fourth outlet of a fourth fluid passage; and a multi-way switching valve rotatably disposed on the base member and performing switching operation among switching positions to open and close the first to the fourth inlets and the first to the fourth outlets. The valve, at a mixed switching position included in the switching positions, causes fluid flowing out from the first outlet to flow into the first inlet and the second inlet, and causes fluid flowing out from the second outlet to flow into the second inlet and the first inlet.

### CROSS-REFERENCE TO RELATED APPLICATION

This application claims the priority benefits of Japanese application no. 2025-061902, filed on Apr. 3, 2025. The entirety of the above-mentioned patent application is hereby incorporated by reference herein and made a part of this specification.

### BACKGROUND

### Technical Field

The disclosure relates to a multi-way switching valve device that switches the flow of fluid in a plurality of directions, and particularly relates to a multi-way switching valve device that adjusts the flow of a heat medium (cooling water) in a temperature control system including an HVAC system (which performs heating, ventilation, air conditioning, and the like in a cabin) mounted on an electric vehicle or the like.

### Related Art

As a conventional multi-way switching valve device, in a vehicle thermal management system including a vehicle heat pump system including an electric cabin heater, a battery system cooling loop that performs heat exchange with a battery, and a drive train cooling loop including a heat exchanger that performs heat exchange with oil of a drive motor, a configuration is known that employs one switching valve (8-way valve) connected to both the battery system cooling loop and the drive train cooling loop and having four switching modes (switching positions) (for example, refer to Patent Document 1).

This switching valve adjusts the flow of cooling water in each passage, and does not mix and flow cooling water flowing through different passages. Therefore, for example, adjustment such as mixing high-temperature cooling water and low-temperature cooling water to flow as cooling water at an appropriate temperature cannot be performed.

Moreover, in a vehicle thermal management system including a refrigerant circuit having an indoor heat exchanger in which a refrigerant circulates and performs heat exchange between the refrigerant and indoor air, a heat medium circuit in which a heat medium circulates to adjust the temperature of a battery and a drive motor, a refrigerant-heat medium heat exchanger that performs heat exchange between the refrigerant and the heat medium (cooling water), and a control part that controls the operation of the refrigerant circuit and the heat medium circuit, as an alternative to a multi-way switching valve device, a plurality of switching valves are disposed in the heat medium circuit, and each switching valve is driven by the control part to control the flow of the heat medium.

In this case, since a plurality of switching valves are employed, it is necessary to control each switching valve, which makes the control complicated, increases the number of parts, and makes the structure complicated.

### Citation List

### Patent Document

Patent Document 1 U.S. Patent No. 11807067

Patent Document 2 Japanese Patent Application Laid-Open Publication No. 2024-63729

The disclosure has been made in view of the above circumstances, and an object thereof is to provide a multi-way switching valve device capable of mixing fluids having different state quantities (for example, temperature), achieving miniaturization, simplification as a system, reduction in the number of parts, and the like, and may be applied particularly in a temperature control system of an electric vehicle.

### SUMMARY

A multi-way switching valve device of the disclosure includes a base member defining a first inlet and a first outlet of a first fluid passage, a second inlet and a second outlet of a second fluid passage, a third inlet and a third outlet of a third fluid passage, and a fourth inlet and a fourth outlet of a fourth fluid passage; and a multi-way switching valve rotatably disposed on the base member and performing switching operation among a plurality of switching positions to open and close the first to the fourth inlets and the first to the fourth outlets, in which the multi-way switching valve is configured to, at a mixed switching position included in the plurality of switching positions, cause fluid flowing out from the first outlet to flow into the first inlet and the second inlet, and cause fluid flowing out from the second outlet to flow into the second inlet and the first inlet.

### BRIEF DESCRIPTION OF THE DRAWINGS

FIG. 1 is a system diagram showing a temperature control system including a multi-way switching valve device according to one embodiment of the disclosure.

FIG. 2 is an external perspective view of the multi-way switching valve device according to one embodiment as viewed from an upper diagonal direction in one direction.

FIG. 3 is an external perspective view of the multi-way switching valve device according to one embodiment as viewed from an upper diagonal in another direction.

FIG. 4 is an external perspective view of the multi-way switching valve device according to one embodiment as viewed from a lower diagonal.

FIG. 5 is an exploded perspective view of the multi-way switching valve device according to one embodiment.

FIG. 6 is a perspective view showing a base member forming a part of the multi-way switching valve device according to one embodiment.

FIG. 7 is a perspective cross-sectional view of a base member forming a part of the multi-way switching valve device according to one embodiment, cut along a plane passing through an axis of a cylindrical recess.

FIG. 8 is a partial plan view of a region of the cylindrical recess of a base member forming a part of the multi-way switching valve device according to one embodiment, as viewed from a direction of the axis.

FIG. 9 is a perspective cross-sectional view of a base member forming a part of the multi-way switching valve device according to one embodiment, cut along a plane perpendicular to the axis.

FIG. 10 is a perspective cross-sectional view of a base member forming a part of the multi-way switching valve device according to one embodiment, cut along a plane perpendicular to the axis.

FIG. 11 is an external perspective view of a multi-way switching valve forming a part of the multi-way switching valve device according to one embodiment, as viewed from upper diagonal direction.

FIG. 12 is an external perspective view of a multi-way switching valve forming a part of the multi-way switching valve device according to one embodiment, as viewed from lower diagonal direction.

FIG. 13 is a plan view of a multi-way switching valve forming a part of the multi-way switching valve device according to one embodiment, as viewed from above.

FIG. 14 is a cross-sectional view of a multi-way switching valve forming a part of the multi-way switching valve device according to one embodiment, cut along a plane perpendicular to the axis in a region of a first outer circumferential surface (upper stage).

FIG. 15 is a cross-sectional view of a multi-way switching valve forming a part of the multi-way switching valve device according to one embodiment, cut along a plane perpendicular to the axis in a region of a second outer circumferential surface (lower stage).

FIG. 16 is a cross-sectional view of a multi-way switching valve forming a part of the multi-way switching valve device according to one embodiment, cut along a plane perpendicular to the axis in an intermediate region between a first outer circumferential surface (upper stage) and a second outer circumferential surface (lower stage).

FIG. 17 is a perspective cross-sectional view of a multi-way switching valve forming a part of the multi-way switching valve device according to one embodiment, cut along a plane perpendicular to the axis in a region of a first outer circumferential surface (upper stage).

FIG. 18 is a perspective transparent view showing a result of simulating a flow of fluid (heat medium) at a mixed switching position (fifth switching position) in a multi-way switching valve forming a part of the multi-way switching valve device according to one embodiment.

FIG. 19 is a perspective view showing a seal member and a spacer member forming a part of the multi-way switching valve device according to one embodiment.

FIG. 20 is a partial cross-sectional view of a multi-way switching valve and a drive unit of the multi-way switching valve device according to one embodiment, cut along a plane including the axis.

FIG. 21 is a perspective view showing an interior of a drive unit forming a part of the multi-way switching valve device according to one embodiment.

FIG. 22 is a schematic diagram schematically showing a first refrigerant-heat medium heat exchanger and a second refrigerant-heat medium heat exchanger forming a part of the multi-way switching valve device according to one embodiment.

FIG. 23 is a system diagram showing a flow of fluid (heat medium, refrigerant) when the multi-way switching valve is located at a first switching position in the multi-way switching valve device according to one embodiment.

FIG. 24 shows a state of the multi-way switching valve when the multi-way switching valve is located at a first switching position in the multi-way switching valve device according to one embodiment, and is a partial cross-sectional view of a region of a first outer circumferential surface (upper stage) and a second outer circumferential surface (lower stage).

FIG. 25 is a system diagram showing a flow of fluid (heat medium) when the multi-way switching valve is located at a second switching position in the multi-way switching valve device according to one embodiment.

FIG. 26 shows a state of the multi-way switching valve when the multi-way switching valve is located at a second switching position in the multi-way switching valve device according to one embodiment, and is a partial cross-sectional view of a region of a first outer circumferential surface (upper stage) and a second outer circumferential surface (lower stage).

FIG. 27 is a system diagram showing a flow of fluid (heat medium) when the multi-way switching valve is located at a third switching position in the multi-way switching valve device according to one embodiment.

FIG. 28 shows a state of the multi-way switching valve when the multi-way switching valve is located at a third switching position in the multi-way switching valve device according to one embodiment, and is a partial cross-sectional view of a region of a first outer circumferential surface (upper stage) and a second outer circumferential surface (lower stage).

FIG. 29 is a system diagram showing a flow of fluid (heat medium) when the multi-way switching valve is located at a fourth switching position in the multi-way switching valve device according to one embodiment.

FIG. 30 shows a state of the multi-way switching valve when the multi-way switching valve is located at a fourth switching position in the multi-way switching valve device according to one embodiment, and is a partial cross-sectional view of a region of a first outer circumferential surface (upper stage) and a second outer circumferential surface (lower stage).

FIG. 31 is a system diagram showing a flow of fluid (heat medium, refrigerant) when the multi-way switching valve is located at a fifth switching position (mixed switching position for mixing fluids (heat medium) having different state quantities) in the multi-way switching valve device according to one embodiment.

FIG. 32 shows a state of the multi-way switching valve when the multi-way switching valve is located at a fifth switching position in the multi-way switching valve device according to one embodiment, and is a partial cross-sectional view of a region of a first outer circumferential surface (upper stage) and a second outer circumferential surface (lower stage).

FIG. 33 is a graph showing a result of simulation of a time during which a storage battery capable of maintaining a range of management temperature (target achievement temperature), as a comparison between the disclosure and prior art, at the fifth switching position (mixed switching position).

FIG. 34 shows a relationship between a contact part of the multi-way switching valve and a stopper of the base member, and is a partial cross-sectional view, cut along a plane perpendicular to the axis.

FIG. 35 is a table showing fifteen types of operation mode 1 to operation mode 15 at five switching positions in the temperature control system including the multi-way switching valve device according to one embodiment.

### DESCRIPTION OF THE EMBODIMENTS

A multi-way switching valve device of the disclosure includes a base member defining a first inlet and a first outlet of a first fluid passage, a second inlet and a second outlet of a second fluid passage, a third inlet and a third outlet of a third fluid passage, and a fourth inlet and a fourth outlet of a fourth fluid passage; and a multi-way switching valve rotatably disposed on the base member and performing switching operation among a plurality of switching positions to open and close the first to the fourth inlets and the first to the fourth outlets, in which the multi-way switching valve is configured to, at a mixed switching position included in the plurality of switching positions, cause fluid flowing out from the first outlet to flow into the first inlet and the second inlet, and cause fluid flowing out from the second outlet to flow into the second inlet and the first inlet.

In the above multi-way switching valve device, the multi-way switching valve may adopt a configuration in which, at the mixed switching position, the first outlet is connected to the third inlet, the third outlet is connected to the first inlet and the second inlet, the second outlet is connected to the first inlet and the second inlet, and the fourth inlet and the fourth outlet are closed.

In the above multi-way switching valve device, the plurality of switching positions may adopt a configuration including a first switching position, a second switching position, a third switching position, a fourth switching position, and a fifth switching position that are sequentially switched upon rotation of the multi-way switching valve in one direction, in which the fifth switching position is the mixed switching position.

In the above multi-way switching valve device, the multi-way switching valve may adopt a configuration in which, at the first switching position, the first outlet is connected to the first inlet, the third outlet is connected to the second inlet, the second outlet is connected to the third inlet, and the fourth inlet and the fourth outlet are closed.

In the above multi-way switching valve device, the multi-way switching valve may adopt a configuration in which, at the second switching position, the first outlet is connected to the second inlet, the third outlet is connected to the first inlet, the second outlet is connected to the third inlet, and the fourth inlet is connected to the fourth outlet; at the third switching position, the first outlet is connected to the second inlet, the third outlet is connected to the first inlet, the second outlet is connected to the fourth inlet, and the fourth outlet is connected to the third inlet; and at the fourth switching position, the first outlet is connected to the third inlet, the third outlet is connected to the first inlet, the second outlet is connected to the fourth inlet, and the fourth outlet is connected to the second inlet.

In the above multi-way switching valve device, the base member may include a cylindrical recess that rotatably accommodates the multi-way switching valve around a predetermined axis; the cylindrical recess may include a first inner circumferential surface and a second inner circumferential surface divided in a direction of the axis, four openings disposed in a circumferential direction on the first inner circumferential surface, and four openings disposed in a circumferential direction on the second inner circumferential surface; and the multi-way switching valve may adopt a configuration having a cylindrical shape rotatably disposed in the cylindrical recess around the axis, and including fifteen hollowed-out passage parts disposed and opening on a first outer circumferential surface corresponding to the first inner circumferential surface and fifteen hollowed-out passage parts disposed and opening on a second outer circumferential surface corresponding to the second inner circumferential surface, to form operating states at the first to fifth switching positions.

In the above multi-way switching valve device, the four openings disposed on the first inner circumferential surface may adopt a configuration corresponding to the third outlet, the second inlet, the fourth outlet, and the fourth inlet; and the four openings disposed on the second inner circumferential surface may adopt a configuration corresponding to the first inlet, the first outlet, the third inlet, and the second outlet.

In the above multi-way switching valve device, the multi-way switching valve may adopt a configuration including a vertical groove passage part that provides communication between the hollowed-out passage part of the first outer circumferential surface and the hollowed-out passage part of the second outer circumferential surface disposed in the direction of the axis so as to connect the third outlet to the first inlet and the second inlet and to connect the second outlet to the first inlet and the second inlet; and the hollowed-out passage part of the first outer circumferential surface and the hollowed-out passage part of the second outer circumferential surface formed to communicate with the vertical groove passage part.

In the above multi-way switching valve device, the multi-way switching valve may adopt a configuration including a rotating shaft centered on the axis, a first hollowed-out part and a second hollowed-out part hollowed out from both sides in the direction of the axis around the rotating shaft, and a communication hole that provides communication between the first hollowed-out part and the second hollowed-out part.

In the above multi-way switching valve device, the first fluid passage may adopt a configuration in which the first fluid passage is a first heat medium passage through which a heat medium that performs heat exchange with a storage battery flows; the second fluid passage is a second heat medium passage through which a heat medium that performs heat exchange with a drive motor that drives wheels flows; the third fluid passage is a third heat medium passage through which a heat medium that performs heat exchange with a refrigerant circulating through a refrigerant passage flows; and the fourth fluid passage is a fourth heat medium passage through which a heat medium that performs heat exchange with outside air via a radiator flows.

In the above multi-way switching valve device, the base member may adopt a configuration including a first inlet side passage and a first outlet side passage that form a part of the first heat medium passage, a second inlet side passage and a second outlet side passage that form a part of the second heat medium passage, a third inlet side passage and a third outlet side passage that form a part of the third heat medium passage, and a fourth inlet side passage and a fourth outlet side passage that form a part of the fourth heat medium passage.

In the above multi-way switching valve device, the base member may adopt a configuration in which a first electric pump that pressure-feeds the heat medium is disposed in the first inlet side passage.

In the above multi-way switching valve device, the base member may adopt a configuration in which a second electric pump that pressure-feeds the heat medium is disposed in the second inlet side passage.

In the above multi-way switching valve device, the base member may adopt a configuration in which a reservoir tank through which the heat medium passes is disposed in the second outlet side passage.

In the above multi-way switching valve device, the base member may adopt a configuration in which a first refrigerant-heat medium heat exchanger that performs heat exchange between the refrigerant and the heat medium is disposed on a downstream side of the reservoir tank in the second outlet side passage.

In the above multi-way switching valve device, the first refrigerant-heat medium heat exchanger may adopt a configuration including a heat exchange part, an intermediate passage forming a part of the second heat medium passage, and a first refrigerant passage forming a part of the refrigerant passage, and an on-off valve is disposed on an upstream side of the first refrigerant passage.

In the above multi-way switching valve device, the base member may adopt a configuration in which a second refrigerant-heat medium heat exchanger that performs heat exchange between the refrigerant and the heat medium is disposed between the third inlet side passage and the third outlet side passage.

In the above multi-way switching valve device, the second refrigerant-heat medium heat exchanger may adopt a configuration including a heat exchange part, an intermediate passage connecting the third inlet side passage and the third outlet side passage, and a second refrigerant passage forming a part of the refrigerant passage, and an expansion valve is disposed on an upstream side of the second refrigerant passage.

According to the multi-way switching valve device having the above configuration, fluids having different state quantities (for example, temperature) may be mixed, and miniaturization, simplification as a system, reduction in the number of parts, and the like can be achieved. In particular, a multi-way switching valve device suitable for a temperature control system of an electric vehicle can be obtained.

Hereinafter, embodiments of the disclosure will be described with reference to the accompanying drawings.

The multi-way switching valve device according to the disclosure is applied, for example, in an electric vehicle, to a temperature control system that performs heat exchange between various functional components (storage battery, drive motor, and the like), cooling water (for example, LLC) as a heat medium, refrigerant (for example, fluorocarbon gas), and cooling water to control temperatures of various functional components to a desired temperature, in addition to an EV air conditioning (HVAC) system that performs heating, ventilation, air conditioning, and the like in a cabin.

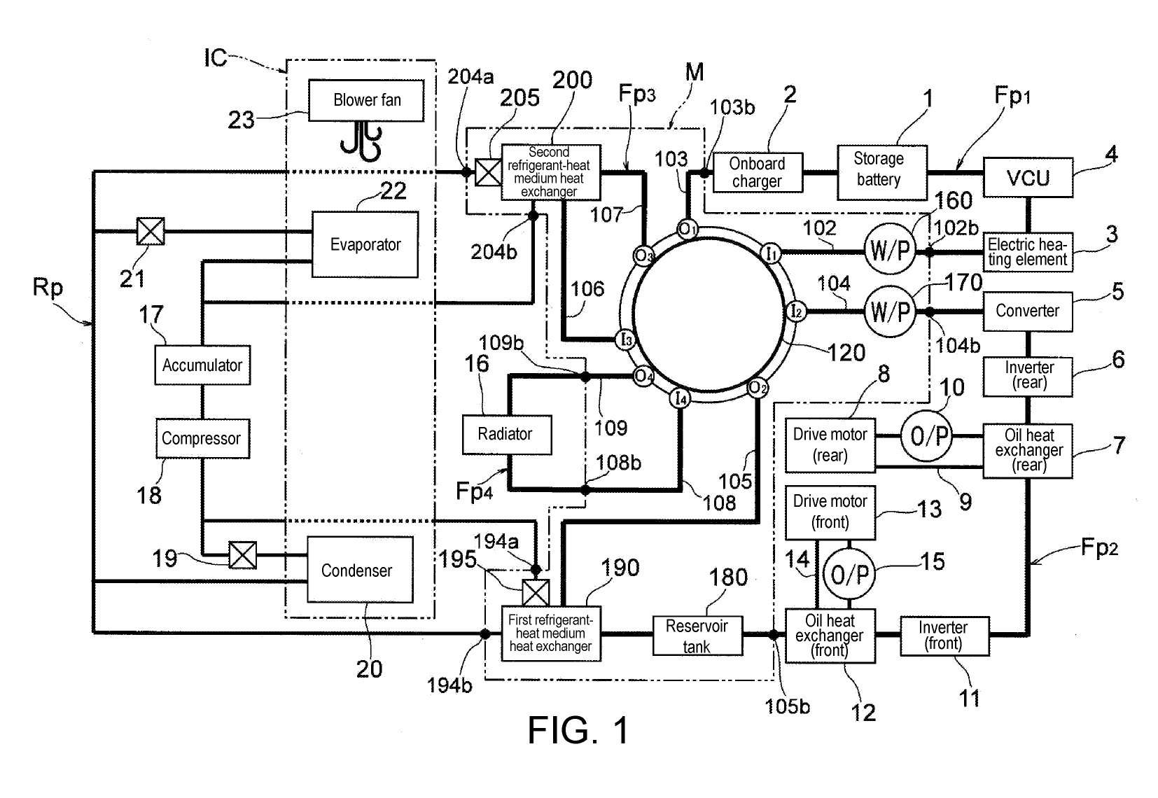

Here, as shown in FIG. 1, the temperature control system includes a first heat medium passage Fp₁ as a first fluid passage, a second heat medium passage Fp₂ as a second fluid passage, a third heat medium passage Fp₃ as a third fluid passage, a fourth heat medium passage Fp₄ as a fourth fluid passage, a refrigerant passage Rp, a storage battery 1, an onboard charger 2, an electric heating element 3, a vehicle control unit 4, a converter 5, an inverter 6, an oil heat exchanger 7, a rear drive motor 8, an oil passage 9, an oil pump 10 as a third electric pump, an inverter 11, an oil heat exchanger 12, a front drive motor 13, an oil passage 14, an oil pump 15 as a third electric pump, a radiator 16, an accumulator 17, a compressor 18, an on-off valve 19, a condenser 20, an expansion valve 21, an evaporator 22, a blower fan 23, a multi-way switching valve device M, and other components.

Here, the condenser 20, the evaporator 22, and the blower fan 23 are disposed in a cabin IC or in a region communicating with the cabin IC.

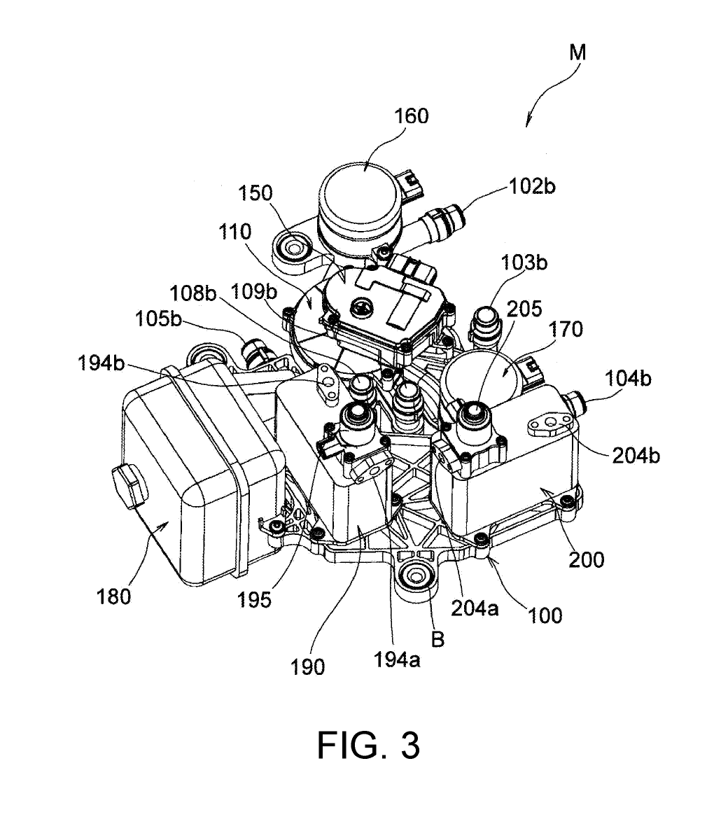

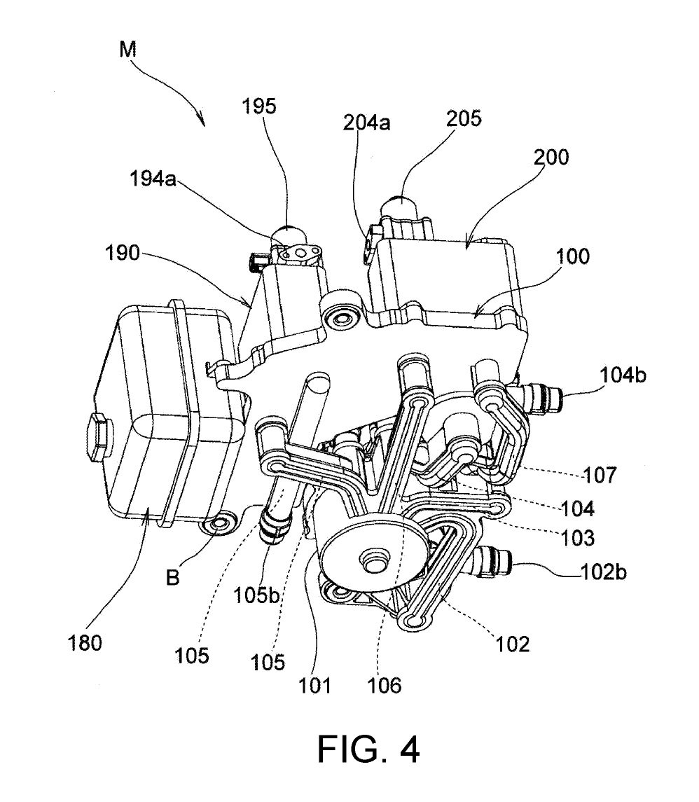

As shown in FIG. 1 to FIG. 5, the multi-way switching valve device M according to one embodiment includes a base member 100, a cover member 110, a multi-way switching valve 120, a seal member 130, a spacer member 140, a drive unit 150, a water pump 160 as a first electric pump, a water pump 170 as a second electric pump, a reservoir tank 180, a first refrigerant-heat medium heat exchanger 190, and a second refrigerant-heat medium heat exchanger 200.

The first heat medium passage Fp₁ is disposed such that an inlet I₁ and an outlet O₁ face the multi-way switching valve 120 of the multi-way switching valve device M. In the first heat medium passage Fp₁, the water pump 160, the electric heating element 3, the vehicle control unit 4, the storage battery 1, and the onboard charger 2 are disposed in order from the inlet I₁ toward the outlet O₁.

The storage battery 1 is, for example, a high-voltage battery of 300V to 400V, and is mainly used as a power source for the rear drive motor 8 and the front drive motor 13, and is disposed at a position facing the first heat medium passage Fp₁ via a heat exchange structure (not shown) so as enable heat exchange with cooling water flowing through the first heat medium passage Fp₁.

Moreover, as a power source for other electrical components, for example, a low-voltage battery (not shown) of 12V to 48V is provided.

In charging the storage battery 1, the onboard charger 2 serves to convert the voltage of, for example, an EV charging station or a household AC power supply to a required voltage, and is disposed at a position facing the first heat medium passage Fp₁ via a heat exchange structure (not shown) so as to enable heat exchange with cooling water flowing through the first heat medium passage Fp₁.

The electric heating element 3 generates heat using the storage battery 1 as a power source, for example, a PTC (positive temperature coefficient) heater is used, and is disposed at a position facing the first heat medium passage Fp₁ so as to enable heat exchange with cooling water flowing through the first heat medium passage Fp₁. Here, in the case of using a PTC heater as the electric heating element 3, due to its self-regulating characteristics, resistance increases with temperature rise and the flowing current is limited, thereby reducing waste of power consumption.

The vehicle control unit 4 is a control unit that starts up using the low-voltage battery as a power source and controls various functions of the vehicle, and is disposed at a position facing the first heat medium passage Fp₁ via a heat exchange structure (not shown) so as to enable heat exchange with cooling water flowing through the first heat medium passage Fp₁.

The second heat medium passage Fp₂ is disposed such that an inlet I₂ and an outlet O₂ face the multi-way switching valve 120 of the multi-way switching valve device M. In the second heat medium passage Fp₂, the water pump 170, the converter 5, the inverter 6, the oil heat exchanger 7, the inverter 11, the oil heat exchanger 12, the reservoir tank 180, and the first refrigerant-heat medium heat exchanger 190 are disposed in order from the inlet I₂ toward the outlet O₂.

The converter 5 is a DC-DC converter that steps down the voltage of the storage battery 1 to a low voltage (for example, 12 to 48V) suitable for charging, for example, the low-voltage battery, and is disposed so as to face the second heat medium passage Fp₂ via a heat exchange structure (not shown) so as to enable heat exchange with cooling water flowing through the second heat medium passage Fp₂.

The inverter 6 converts direct current to alternating current and boosts the voltage of the storage battery 1 to a high voltage (for example, 300 to 800V) so as to be suitable for driving the rear drive motor 8, and is disposed at a position facing the second heat medium passage Fp₂ via a heat exchange structure (not shown) so as to enable heat exchange with cooling water flowing through the second heat medium passage Fp₂.

The oil heat exchanger 7 serves to transfer heat generated by the rear drive motor 8 to cooling water via oil, and is disposed at a position facing the second heat medium passage Fp₂ so as to enable heat exchange between the cooling water flowing through the second heat medium passage Fp₂ and the oil.

The rear drive motor 8 drives the rear wheels of the vehicle, and is cooled via oil that undergoes heat exchange with cooling water by circulating the oil flowing through the oil passage 9 with the oil pump 10. The oil pump 10 is driven using the low-voltage battery as a power source.

The inverter 11 converts direct current to alternating current and boosts the voltage of the storage battery 1 to a high voltage (for example, 300 to 800V) so as to be suitable for driving the front drive motor 13, and is disposed at a position facing the second heat medium passage Fp₂ via a heat exchange structure (not shown) so as to enable heat exchange with cooling water flowing through the second heat medium passage Fp₂.

The oil heat exchanger 12 serves to transfer heat generated by the front drive motor 13 to cooling water via oil, and is disposed at a position facing the second heat medium passage Fp₂ so as to enable heat exchange between the cooling water flowing through the second heat medium passage Fp₂ and the oil.

The front drive motor 13 drives the front wheels of the vehicle, and is cooled via oil that performs heat exchange with cooling water by circulating the oil flowing through the oil passage 14 with the oil pump 15. The oil pump 15 is driven using the low-voltage battery as a power source.

The third heat medium passage Fp₃ is disposed such that an inlet I₃ and an outlet O₃ face the multi-way switching valve 120 of the multi-way switching valve device M. Moreover, the second refrigerant-heat medium heat exchanger 200 is disposed midway in the third heat medium passage Fp₃.

The fourth heat medium passage Fp₄ is disposed such that an inlet I₄ and an outlet O₄ face the multi-way switching valve 120 of the multi-way switching valve device M. The radiator 16 is disposed midway in the fourth heat medium passage Fp₄.

The radiator 16 dissipates heat of the cooling water flowing through the fourth heat medium passage Fp₄ to the outside air.

The refrigerant passage Rp is disposed so as to pass through the first refrigerant-heat medium heat exchanger 190 and the second refrigerant-heat medium heat exchanger 200. The accumulator 17, the compressor 18, the on-off valve 19, the condenser 20, the expansion valve 21, and the evaporator 22 are disposed in the refrigerant passage Rp.

The accumulator 17 is disposed in the refrigerant passage Rp on the downstream side of the evaporator 22 and on the upstream side of the compressor 18, and functions to separate the refrigerant into gas and liquid and send only the gaseous refrigerant to the compressor 18.

The compressor 18 is driven using the storage battery 1 as a power source, and compresses the refrigerant to high temperature and high pressure and sends it out.

The on-off valve 19 is a solenoid valve driven by a low-voltage battery, and opens and closes the refrigerant passage Rp leading to the condenser 20.

The condenser 20 liquefies the high temperature and high pressure gaseous refrigerant sent from the compressor 18 and releases heat to the outside (inside the cabin IC).

The expansion valve 21 is a solenoid valve driven by a low-voltage battery, and is disposed in the refrigerant passage Rp on the downstream side of the condenser 20 and the first refrigerant-heat medium heat exchanger 190, and rapidly expands the refrigerant to make it low temperature and low pressure.

The evaporator 22 absorbs heat from the outside (inside the cabin IC) through the low-temperature and low-pressure refrigerant that has passed through the expansion valve 21.

The blower fan 23 is driven by a low-voltage battery, and generates forced convection of air to promote heat dissipation operation by the condenser 20 and cooling operation by the evaporator 22 inside the cabin IC.

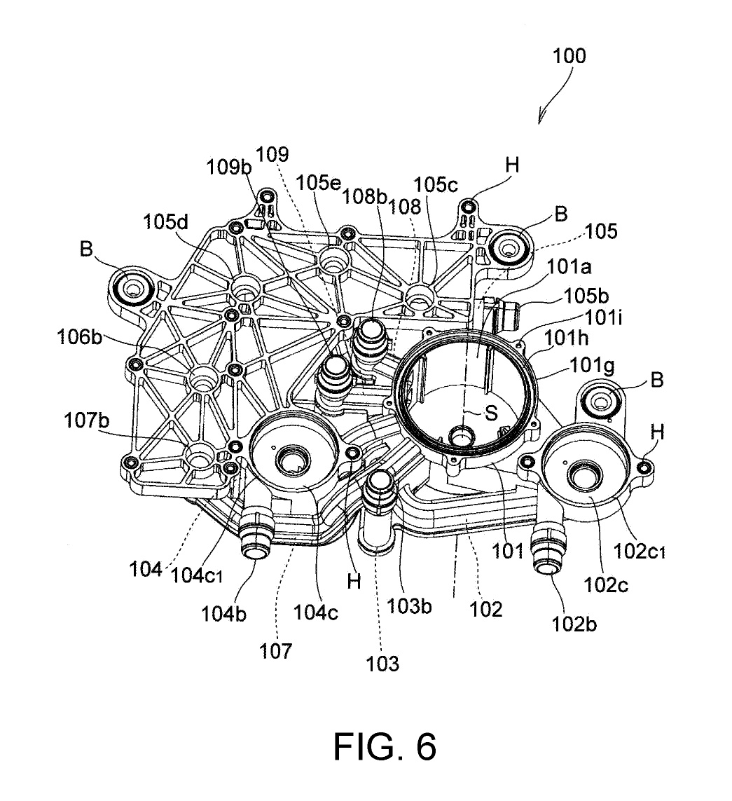

In the multi-way switching valve device M according to one embodiment, the base member 100 is molded using resin material, and as shown in FIG. 6 to FIG. 10, includes a cylindrical recess 101 centered on an axis S, a first inlet side passage 102 and a first outlet side passage 103 that form a part of the first heat medium passage Fp₁, a second inlet side passage 104 and a second outlet side passage 105 that form a part of the second heat medium passage Fp₂, a third inlet side passage 106 and a third outlet side passage 107 that form a part of the third heat medium passage Fp₃, a fourth inlet side passage 108 and a fourth outlet side passage 109 that form a part of the fourth heat medium passage Fp₄, a plurality of (fourteen) embedded screw holes H, and a plurality of (three) assembled mounting boss parts B.

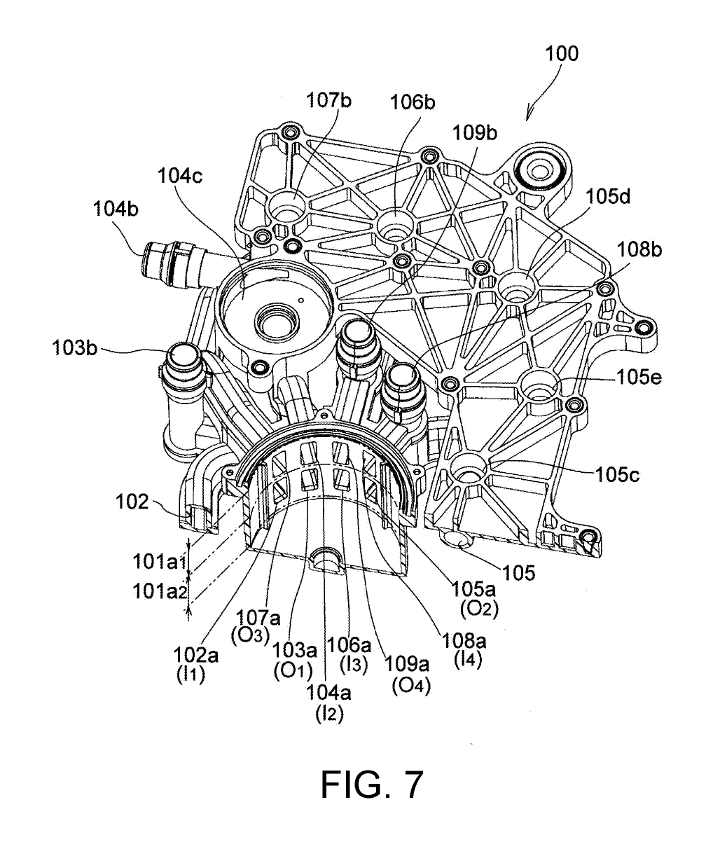

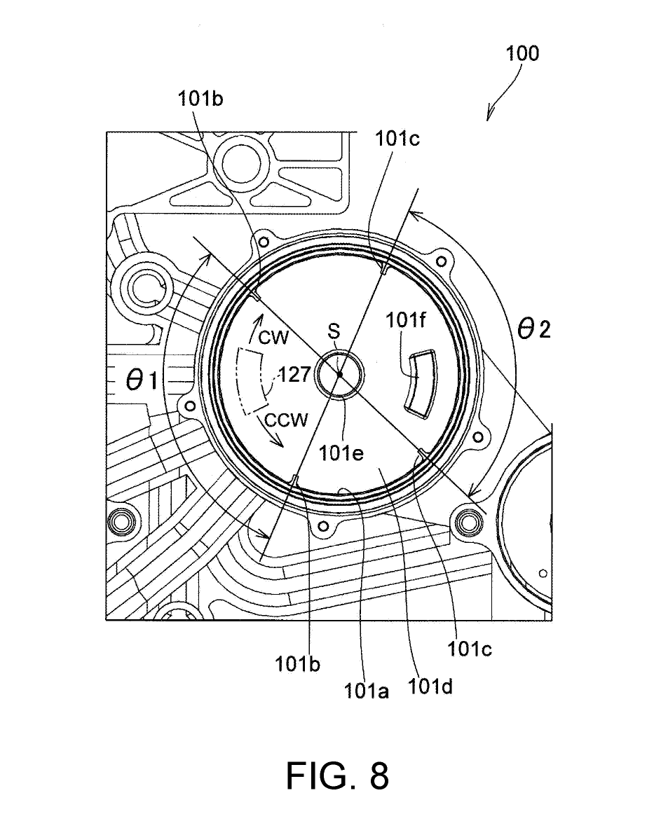

As shown in FIG. 7 and FIG. 8, the cylindrical recess 101 includes a plurality of openings (inlet I₁, outlet O₁, inlet I₂, outlet O₂, inlet I₃, outlet O₃, inlet I₄, outlet O₄) on an inner circumferential surface 101a centered on the axis S within an angle range θ1 (here, approximately 110 degrees) narrower than a half circumference. Here, as shown in FIG. 7, the inner circumferential surface 101a includes a first inner circumferential surface 101a₁ and a second inner circumferential surface 101a₂ divided in the axis Sdirection, with four openings (outlet O₃, inlet I₂, outlet O₄, inlet I₄) disposed in the circumferential direction on the first inner circumferential surface 101a₁, and four openings (inlet I₁, outlet O₁, inlet I₃, outlet O₂) disposed in the circumferential direction on the second inner circumferential surface 101a₂.

Moreover, as shown in FIG. 8, the inner circumferential surface 101a includes a pair of projection parts 101b for positioning the seal member 130 at a position corresponding to the angle range θ1, and a pair of projection parts 101c for positioning the spacer member 140 in an angle range θ2 (θ1=θ2) located in a region opposite to the angle range θ1 across the axis 5.

Furthermore, as shown in FIG. 8, the cylindrical recess 101 includes a bearing recess 101e for supporting an end part 121a of a rotating shaft 121 of the multi-way switching valve 120 and a stopper 101f for restricting rotation on a bottom wall 101d, and as shown in FIG. 6, includes an annular seal groove 101h for fitting an O-ring Sr₁ and five screw holes 101i on the flange part 101g.

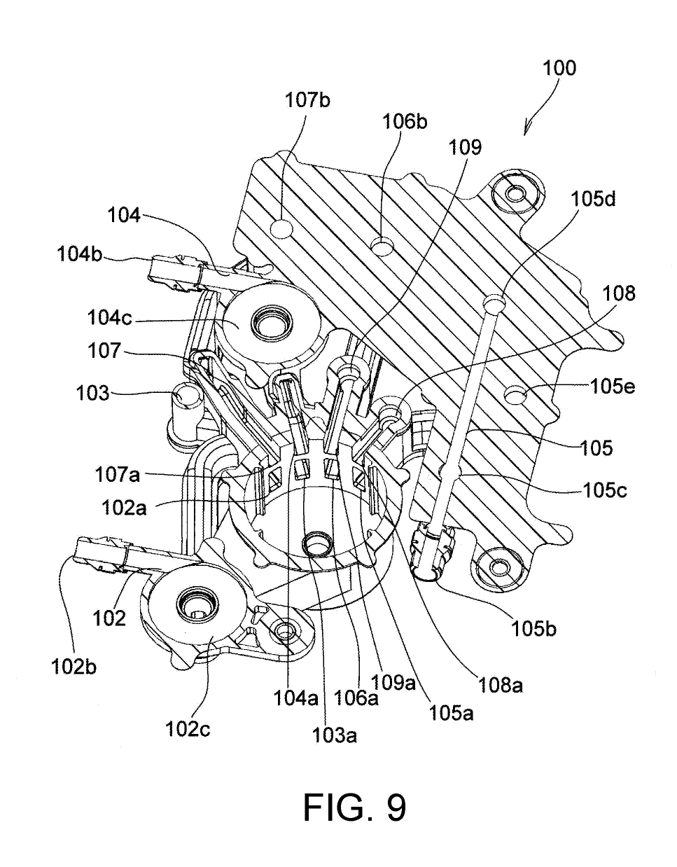

As shown in FIG. 6, FIG. 7, and FIG. 9, the first inlet side passage 102 includes a first inlet 102a through which cooling water flows into the first heat medium passage Fp₁, a first downstream end port 102b, and a first pump accommodation recess 102c in the middle.

The first inlet 102a is the inlet I₁ that opens to the second inner circumferential surface 101a₂.

The first downstream end port 102b is connected to the first heat medium passage Fp₁ on the upstream side of the electric heating element 3.

The first pump accommodation recess 102c is a region that accommodates the water pump 160, and as shown in FIG. 6, is formed parallel to the axis S and open in the same direction as the cylindrical recess 101, and includes a flange part 102c₁ that fixes the water pump 160 at the opening end thereof.

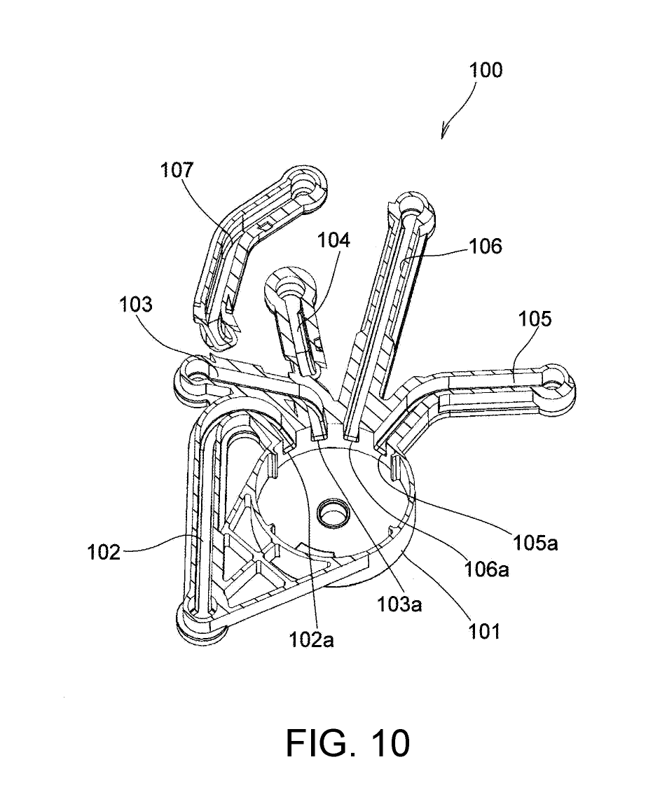

As shown in FIG. 6, FIG. 7, and FIG. 10, the first outlet side passage 103 includes a first outlet 103a through which cooling water flows out from the first heat medium passage Fp₁ into the cylindrical recess 101, and a first upstream end port 103b.

The first outlet 103a is the outlet O₁ that opens at the second inner circumferential surface 101a₂.

The first upstream end port 103b is connected to the first heat medium passage Fp₁ on the downstream side of the onboard charger 2.

As shown in FIG. 6, FIG. 7, and FIG. 9, the second inlet side passage 104 includes a second inlet 104a through which cooling water flows into the second heat medium passage Fp₂, a second downstream end port 104b, and a second pump accommodation recess 104c in the middle thereof.

The second inlet 104a is the inlet I₂ that opens to the first inner circumferential surface 101a₁.

The second downstream end port 104b is connected to the second heat medium passage Fp₂ on the upstream side of the converter 5.

The second pump accommodation recess 104c is a region that accommodates the water pump 170, is formed parallel to the axis S and open in the same direction as the cylindrical recess 101, and includes a flange part 104c₁ that fixes the water pump 170 at the opening end thereof.

As shown in FIG. 6, FIG. 7, and FIG. 9, the second outlet side passage 105 includes a second outlet 105a through which cooling water flows out from the second heat medium passage Fp₂ into the cylindrical recess 101, a second upstream end port 105b, a branch port 105c in the middle parallel to the axis S and open in the same direction as the cylindrical recess 101, and two disconnection ports 105d and 105e that are divided from the middle on the downstream side of the branch port 105c and open parallel to the axis S and in the same direction as the cylindrical recess 101.

The second outlet 105a is the outlet O₂ that opens to the second inner circumferential surface 101a₂.

The second upstream end port 105b is connected to the second heat medium passage Fp₂ on the downstream side of the oil heat exchanger 12.

The reservoir tank 180 is connected to the branch port 105c so as to communicate from the axis S direction.

A first refrigerant-heat medium heat exchanger 190 is connected to the two disconnection ports 105d and 105e so as to communicate from the axis S direction.

As shown in FIG. 6, FIG. 7, and FIG. 10, the third inlet side passage 106 includes a third inlet 106a through which cooling water flows into the third heat medium passage Fp₃, and a third downstream end port 106b.

The third inlet 106a is the inlet I₃ that opens at the second inner circumferential surface 101a₂.

The third downstream end port 106b is formed parallel to the axis S and open in the same direction as the cylindrical recess 101.

As shown in FIG. 6, FIG. 7, and FIG. 9, the third outlet side passage 107 includes a third outlet 107a through which cooling water flows out from the third heat medium passage Fp₃ into the cylindrical recess 101, and a third upstream end port 107b.

The third outlet 107a is the outlet O₃ that opens at the first inner circumferential surface 101a₁.

The third upstream end port 107b is formed parallel to the axis S and open in the same direction as the cylindrical recess 101.

Moreover, the third downstream end port 106b and the third upstream end port 107b are connected to the second refrigerant-heat medium heat exchanger 200 so as to communicate from the axis S direction.

As shown in FIG. 6, FIG. 7, and FIG. 9, the fourth inlet side passage 108 includes a fourth inlet 108a through which cooling water flows into the fourth heat medium passage Fp₄, and a fourth downstream end port 108b.

The fourth inlet 108a is the inlet I₄ that opens to the first inner circumferential surface 101a₁.

The fourth downstream end port 108b is formed parallel to the axis S and open in the same direction as the cylindrical recess 101.

As shown in FIG. 6, FIG. 7, and FIG. 9, the fourth outlet side passage 109 includes a fourth outlet 109a through which cooling water flows out from the fourth heat medium passage Fp₄ into the cylindrical recess 101, and a fourth upstream end port 109b.

The fourth outlet 109a is the outlet O₄ that opens at the first inner circumferential surface 101a₁.

The fourth upstream end port 109b is formed parallel to the axis S and open in the same direction as the cylindrical recess 101.

Moreover, the fourth downstream end port 108b and the fourth upstream end port 109b are connected to a connection part forming a part of the fourth heat medium passage Fp₄ of the radiator 16 so as to communicate from the axis S direction.

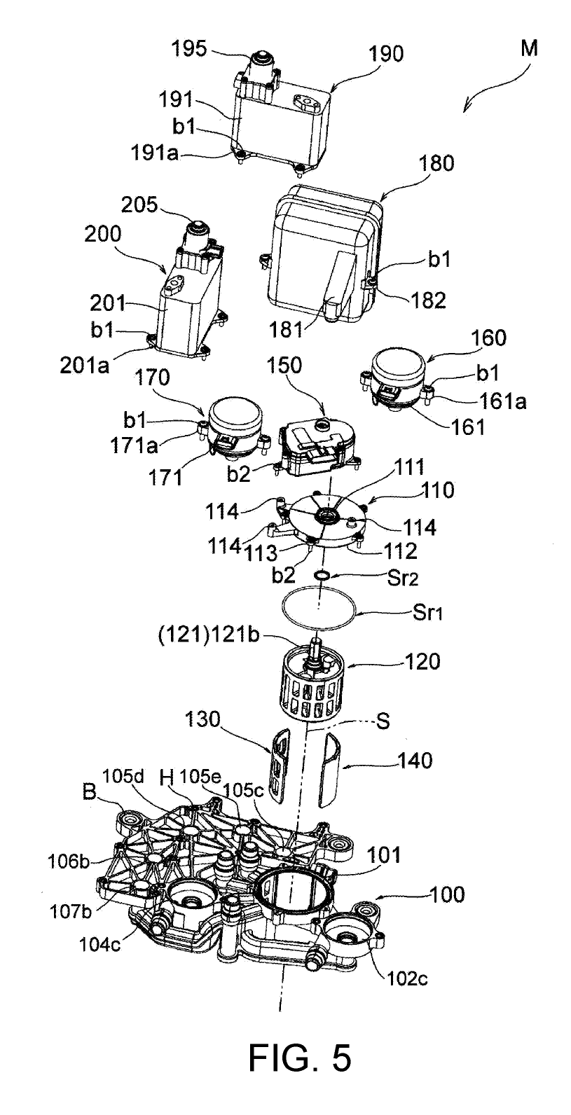

The cover member 110 is formed in a substantially disc shape from resin material, covers the cylindrical recess 101, and serves as a base for fixing the drive unit 150, and as shown in FIG. 5, includes a circular hole 111 through which an end part 121b of the rotating shaft 121 of the multi-way switching valve 120 passes, an annular joint part 112 joined to the flange part 101g of the cylindrical recess 101, five arm parts 113 formed to protrude from the annular joint part 112 and having circular holes through which screws b2 pass, and three boss parts 114 having screw holes into which the screws b2 for fixing the drive unit 150 are screwed.

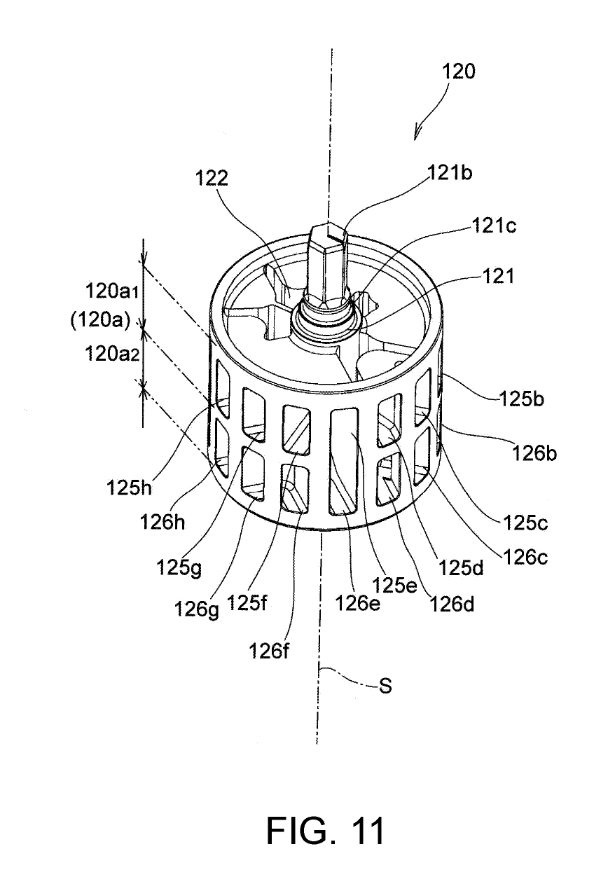

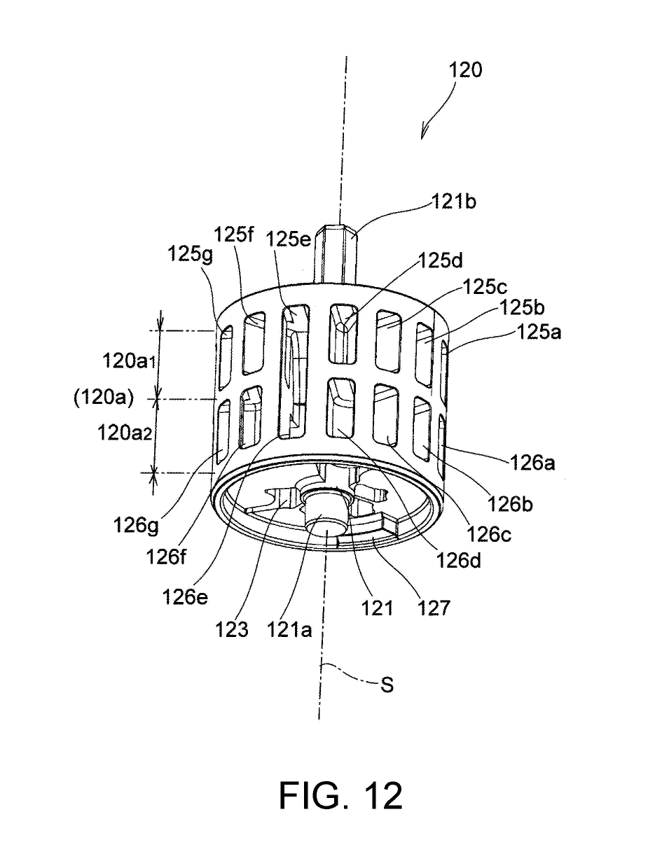

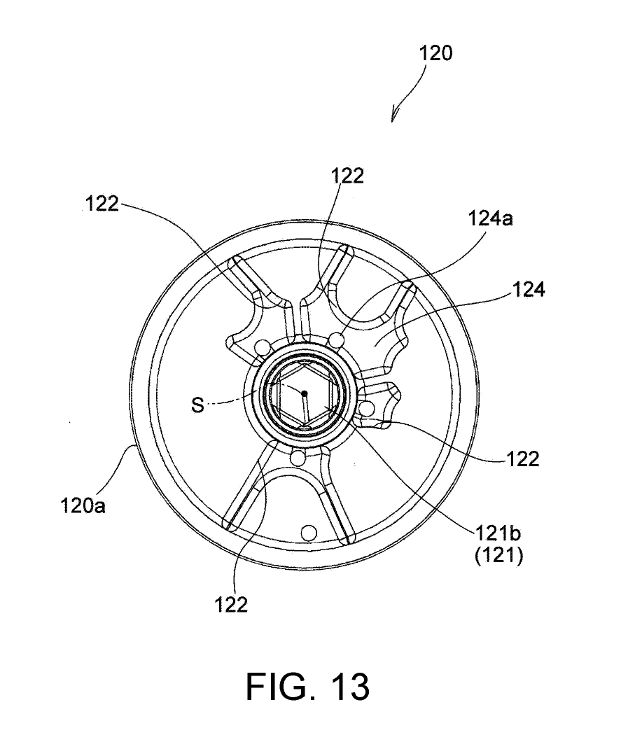

The multi-way switching valve 120 is molded from resin material into a columnar shape centered on the axis S, and as shown in FIG. 11 to FIG. 17, includes a rotating shaft 121 centered on the axis S, a first hollowed-out part 122 and a second hollowed-out part 123 that are hollowed out from both sides in the axis S direction around the rotating shaft 121, a partition wall 124 that partitions the first hollowed-out part 122 and the second hollowed-out part 123, fifteen hollowed-out passage parts 125a to 125o on a first outer circumferential surface 120a₁ that is divided in the axis S direction in an outer circumferential surface 120a and fifteen hollowed-out passage parts 126a to 126o on a second outer circumferential surface 120a₂, and a contact part 127 in the vicinity of the second hollowed-out part 123.

The rotating shaft 121 includes respective end parts 121a and 121b, and an annular seal part 121c formed on the end part 121b side.

The end part 121a is inserted into the bearing recess 101e formed in the bottom wall 101d of the cylindrical recess 101 of the base member 100 and is rotatably supported.

The end part 121b is connected to a gear 155 of the drive unit 150 through the circular hole 111 of the cover member 110.

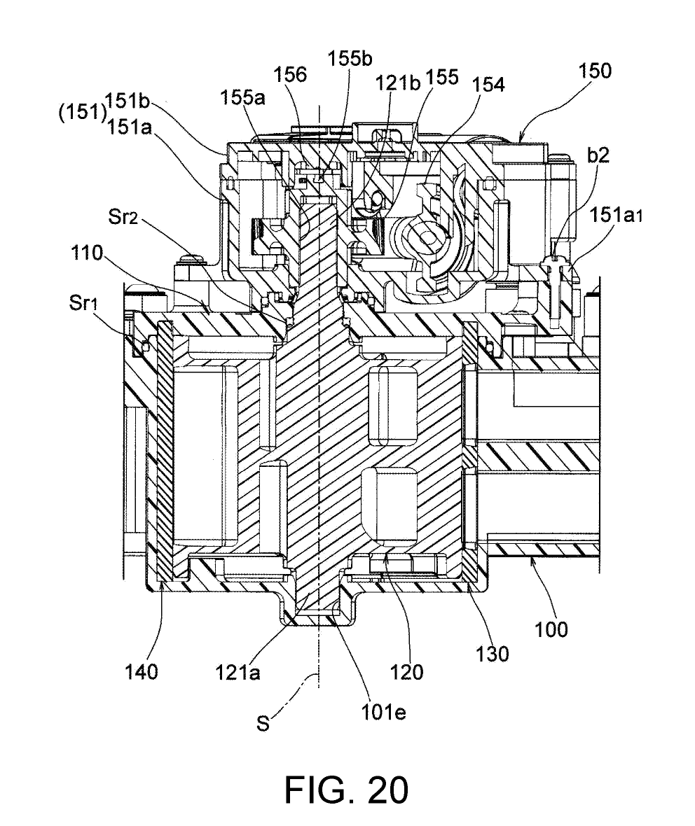

The annular seal part 121c, as shown in FIG. 20, sandwiches an O-ring Sr₂ in cooperation with the cover member 110.

The partition wall 124 includes a plurality of communication holes 124a that allow communication between the first hollowed-out part 122 and the second hollowed-out part 123.

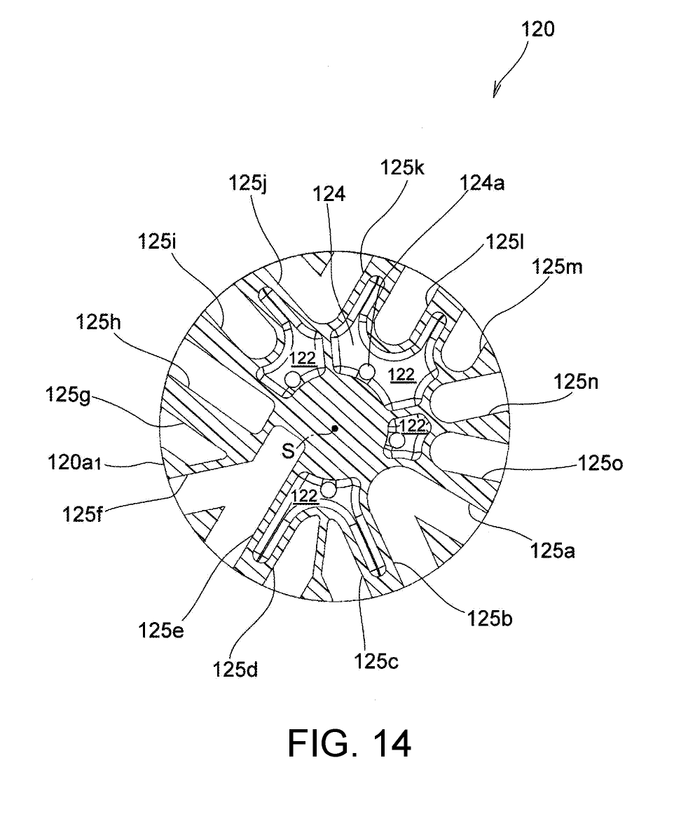

The hollowed-out passage parts 125a to 125o, as shown in FIG. 14, are disposed radially and formed to extend toward the center on the rotating shaft 121 side.

Moreover, the hollowed-out passage part 125a and the hollowed-out passage part 125b communicate at the inner side, the hollowed-out passage part 125e and the hollowed-out passage part 125f communicate at the inner side, and the hollowed-out passage part 125j and the hollowed-out passage part 125k communicate at the inner side.

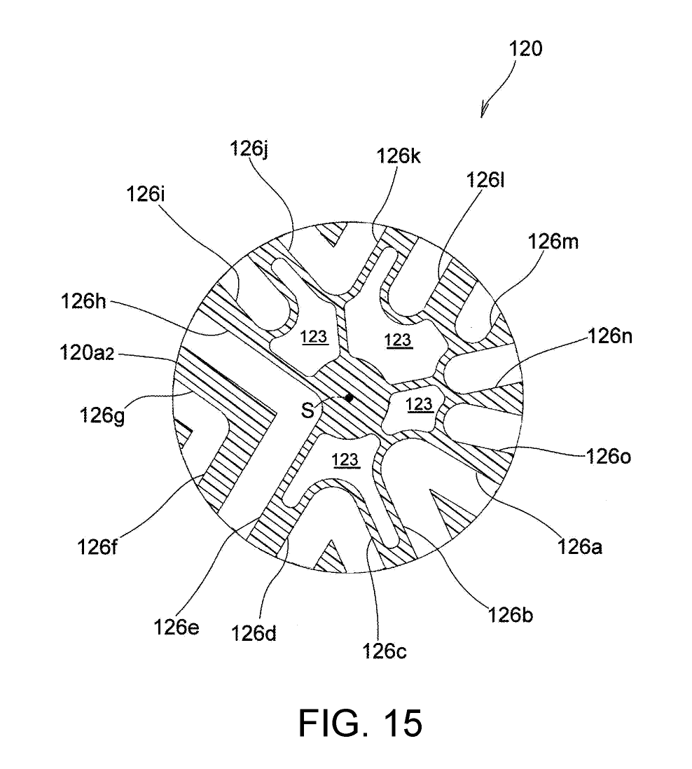

The hollowed-out passage parts 126a to 126o, as shown in FIG. 15, are disposed radially and formed to extend toward the center on the rotating shaft 121 side.

Moreover, the hollowed-out passage part 126a and the hollowed-out passage part 126b communicate at the inner side, the hollowed-out passage part 126c and the hollowed-out passage part 126d communicate at the inner side, the hollowed-out passage part 126e and the hollowed-out passage part 126h communicate at the inner side, the hollowed-out passage part 126f and the hollowed-out passage part 126g communicate at the inner side, and the hollowed-out passage part 126j and the hollowed-out passage part 126k communicate at the inner side.

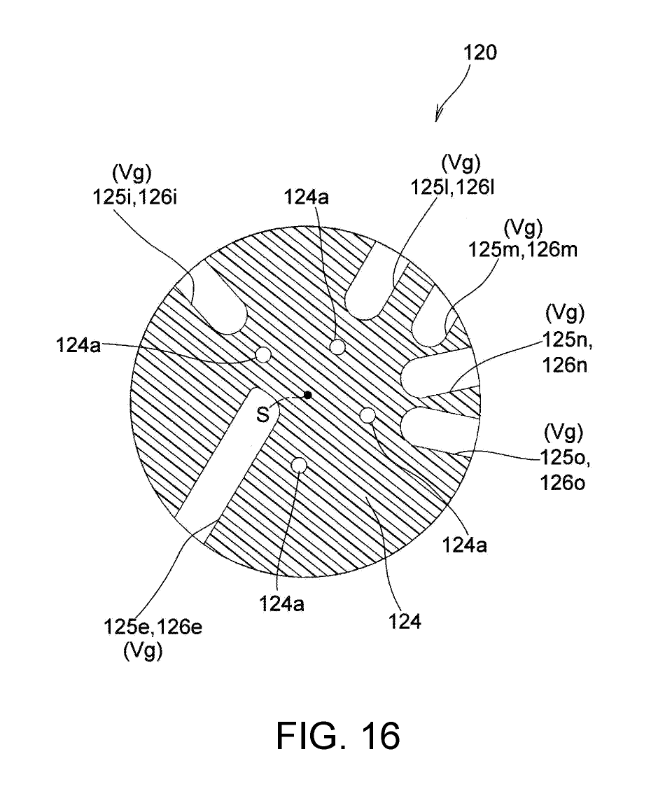

Furthermore, as shown in FIG. 16, the hollowed-out passage part 125e and the hollowed-out passage part 126e, the hollowed-out passage part 125i and the hollowed-out passage part 126i, the hollowed-out passage part 125l and the hollowed-out passage part 126l, the hollowed-out passage part 125m and the hollowed-out passage part 126m, the hollowed-out passage part 125n and the hollowed-out passage part 126n, and the hollowed-out passage part 125o and the hollowed-out passage part 126o are each formed as vertical groove passage parts Vg that communicate with each other in the axis S direction.

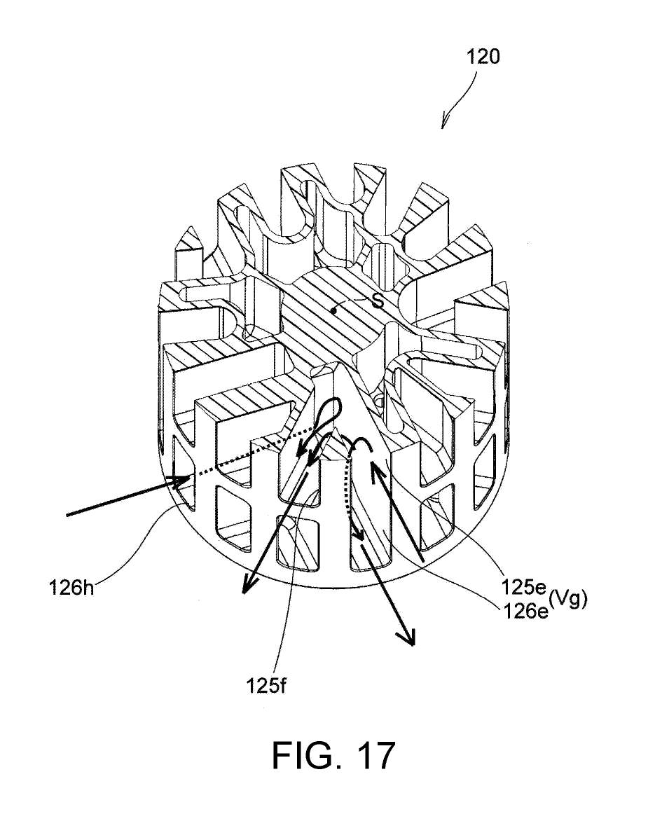

In the above configuration, as shown by the arrows in FIG. 17, cooling water that flows into the hollowed-out passage part 125e flows out from the hollowed-out passage part 126e and the hollowed-out passage part 125f, and the cooling water that flows in from the hollowed-out passage part 126h flows out from the hollowed-out passage part 125f and the hollowed-out passage part 126e. Therefore, the cooling water that flows in from the hollowed-out passage part 125e and the cooling water that flows in from the hollowed-out passage part 126h mix and flow out from the hollowed-out passage part 126e and flow out from the hollowed-out passage part 125f.

That is, the multi-way switching valve 120 is formed to include a vertical groove passage part Vg that communicates the hollowed-out passage part 125e of the first outer circumferential surface 120a₁ with the hollowed-out passage part 126e of a second outer circumferential surface 120a₂, and the hollowed-out passage part 125f of the first outer circumferential surface 120a₁ and the hollowed-out passage part 126h of the second outer circumferential surface 120a₂ formed to communicate with the vertical groove passage part Vg.

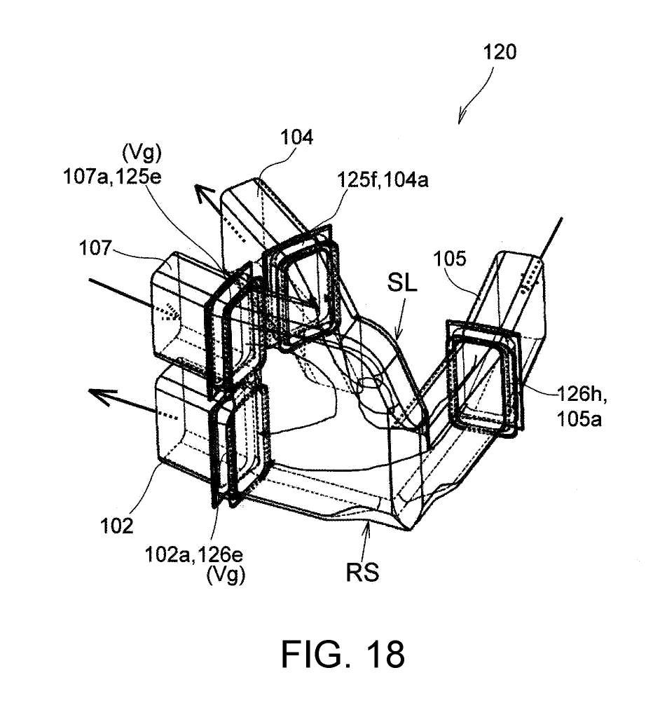

FIG. 18 shows the results of simulating the fluid flow shown in FIG. 17. As may be seen from the flow diagram in the figure, the cooling water that flows in from the hollowed-out passage part 125e collides with the inner wall at the back, the flow direction is bent, and it flows toward the lower hollowed-out passage part 126e and toward the lateral hollowed-out passage part 125f. The cooling water that flows into the hollowed-out passage part 126h collides with the inner wall at the back, the flow direction is bent, and it flows toward the hollowed-out passage part 126e and toward the upper hollowed-out passage part 125f. Accordingly, the fluid flowing through the hollowed-out passage part 126e and the hollowed-out passage part 125f flows out as a mixed flow.

Here, in particular, by forming the RS region with a corner R in a streamlined manner and forming the SL region with a slope (inclined surface), the cooling water may be mixed and smoothly flow toward each passage.

As shown in FIG. 8, the contact part 127 contacts the stopper 101f formed on the bottom wall 101d of the cylindrical recess 101 of the base member 100 to restrict the rotation of the multi-way switching valve 120. That is, the multi-way switching valve 120 rotates clockwise CW and counterclockwise CCW about the axis S and contacts the stopper 101f, and further rotation of the multi-way switching valve 120 is restricted.

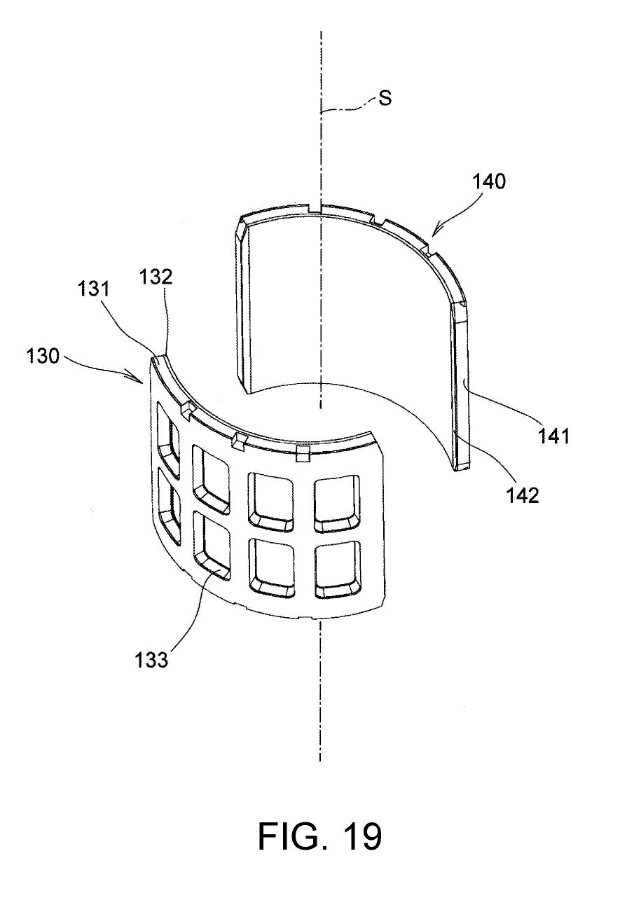

As shown in FIG. 19, the seal member 130 is assembled in an arc plate shape centered on the axis S, and includes an outer arc plate 131 formed of a rubber material, an inner arc plate 132 formed of a crystalline resin material, for example, a fluorine resin such as polytetrafluoroethylene (PTFE), and a plurality of (here, eight) substantially rectangular holes 133.

The plurality of rectangular holes 133 are each formed to correspond to the plurality of openings (the first inlet 102a, the first outlet 103a, the second inlet 104a, the second outlet 105a, the third inlet 106a, the third outlet 107a, the fourth inlet 108a, and the fourth outlet 109a) formed on the inner circumferential surface 101a of the cylindrical part 101.

Moreover, as shown in FIG. 8 and FIG. 20, the seal member 130 is disposed between the inner circumferential surface 101a of the cylindrical recess 101 of the base member 100 and the outer circumferential surface 120a of the multi-way switching valve 120 at a position corresponding to the angle range θ1 between the pair of projection parts 101b.

As shown in FIG. 19, the spacer member 140 is assembled in an arc plate shape centered on the axis S, and includes an outer arc plate 141 formed of rubber material and an inner arc plate 142 formed of crystalline resin material, for example fluorine resin such as polytetrafluoroethylene (PTFE).

As shown in FIG. 8 and FIG. 20, the spacer member 140 is disposed between the inner circumferential surface 101a of the cylindrical recess 101 of the base member 100 and the outer circumferential surface 120a of the multi-way switching valve 120 at a position corresponding to the angle range θ2 between the pair of projection parts 101c, that is, in a region on the opposite side of the seal member 130 across the axis S.

In this way, since the seal member 130 and the spacer member 140 are disposed to face each other across the axis S, an alignment effect of the multi-way switching valve 120 may be obtained, and sliding resistance can be reduced compared to a case where seal members are disposed over the entire circumference, thereby reducing the driving force of the multi-way switching valve 120.

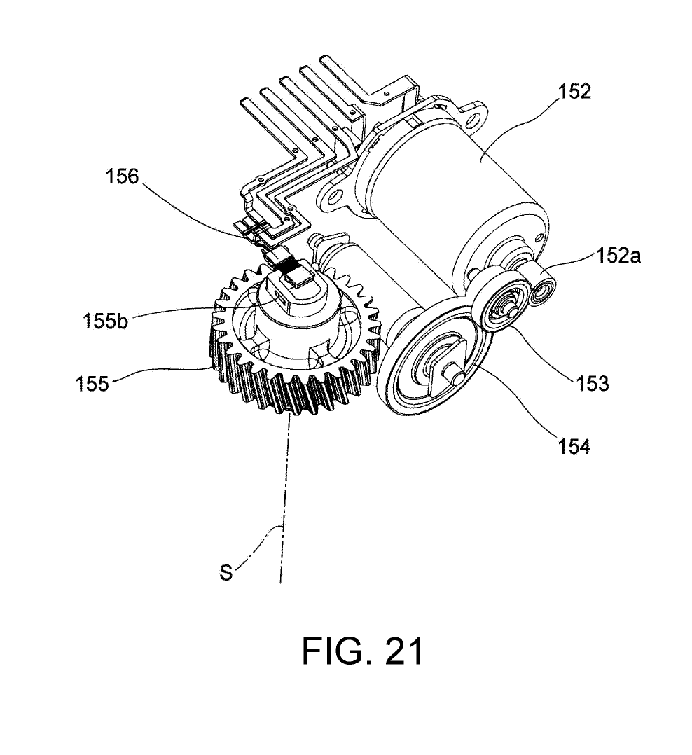

As shown in FIG. 20 and FIG. 21, the drive unit 150 includes a housing 151, a motor 152 having a drive gear 152a, reduction gears 153 and 154, a gear 155, and a Hall IC 156.

The housing 151 surrounds the entirety except for a connection hole 155a of the gear 155, and is configured by a housing body 151a and a housing cover 151b, and as shown in FIG. 20, includes three boss parts 151a1 through which the screws b2 pass.

The motor 152 is, for example, a DC motor, and is driven by a low-voltage battery.

The gear 155 includes a connection hole 155a to which the end part 121b of the rotating shaft 121 is connected, and a detected part 155b embedded therein including a permanent magnet or the like.

The Hall IC 156 is disposed on the housing cover 151b so as to face the detected part 155b, and is configured to detect the rotational position of the multi-way switching valve 120.

The drive unit 150 having the above configuration is joined to the outside of the cover member 110 from the axis S direction, and is fixed to the cover member 110 by the screws b2.

The water pump 160 is an electric centrifugal pump driven by a low-voltage battery, and as shown in FIG. 5, includes a fitting flange part 161 and two boss parts 161a through which screws b1 pass. The water pump 160 is disposed in the first pump accommodation recess 102c of the base member 100 from the axis S direction, the fitting flange part 161 is joined to the flange part 102c₁, and is fixed to the base member 100 by the screws b1.

The water pump 170 is an electric centrifugal pump driven by a low-voltage battery, and as shown in FIG. 5, includes a fitting flange part 171 and two boss parts 171a through which the screws b1 pass. The water pump 170 is disposed in the second pump accommodation recess 104c of the base member 100 from the axis S direction, the fitting flange part 171 is joined to the flange part 104c₁, and is fixed to the base member 100 by the screws b1.

The reservoir tank 180 passes cooling water therethrough and adjusts the internal pressure that fluctuates according to temperature change of the cooling water, and as shown in FIG. 5, includes a passage part 181 that forms an internal passage (not shown) communicating with the branch port 105c, and two boss parts 182 through which the screws b1 pass. The reservoir tank 180 is joined so as to communicate with the branch port 105c from the axis S direction, and is fixed to the base member 100 by the screws b1 via the boss parts 182.

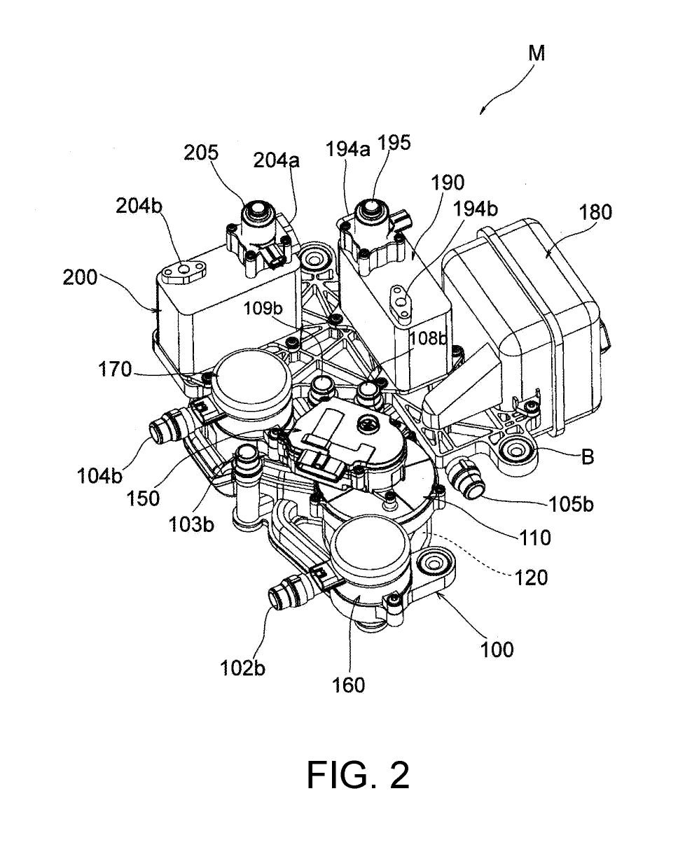

The first refrigerant-heat medium heat exchanger 190, as shown in FIG. 1 and FIG. 2, performs heat exchange between the refrigerant flowing through the refrigerant passage Rp and the cooling water flowing through the second heat medium passage Fp₂, and is disposed in the base member 100 on the downstream side of the reservoir tank 180 in the second outlet side passage 105.

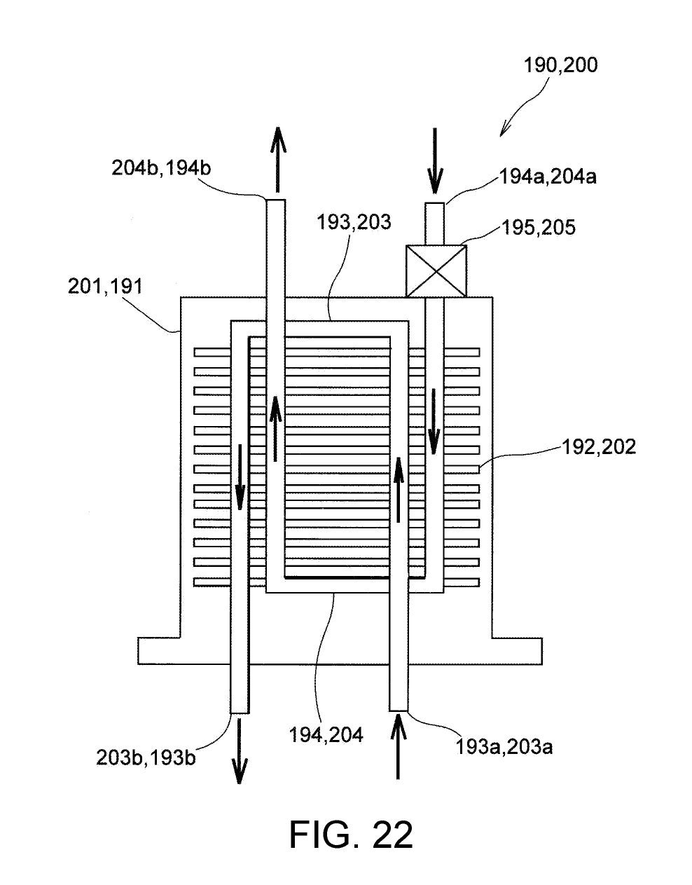

The first refrigerant-heat medium heat exchanger 190, as shown in FIG. 5 and FIG. 22, includes a housing 191, a heat exchange part 192 in which a plurality of metal plates with high heat conductivity are disposed within the housing 191, an intermediate passage 193 that forms a part of the second heat medium passage Fp₂, namely, the second outlet side passage 105, a first refrigerant passage 194 that forms a part of the refrigerant passage Rp, and an on-off valve 195 disposed on the upstream side of the first refrigerant passage 194.

The housing 191 includes four boss parts 191a through which the screws b1 pass, an inlet joint part 193a and an outlet joint part 193b of the intermediate passage 193, and an inlet connection part 194a and an outlet connection part 194b of the first refrigerant passage 194.

The on-off valve 195 is a solenoid valve driven by a low-voltage battery, and opens and closes the upstream side of the first refrigerant passage 194.

The second refrigerant-heat medium heat exchanger 200, as shown in FIG. 1 and FIG. 2, performs heat exchange between the refrigerant flowing through the refrigerant passage Rp and the cooling water flowing through the third heat medium passage Fp₃, and is disposed in the base member 100 between the third inlet side passage 106 and the third outlet side passage 107.

The second refrigerant-heat medium heat exchanger 200, as shown in FIG. 5 and FIG. 22, includes a housing 201, a heat exchange part 202 in which a plurality of metal plates with high heat conductivity are disposed within the housing 201, an intermediate passage 203 that connects the third inlet side passage 106 and the third outlet side passage 107, a second refrigerant passage 204 that forms a part of the refrigerant passage Rp, and an expansion valve 205 disposed on the upstream side of the second refrigerant passage 204.

The housing 201 includes four boss parts 201a through which the screws b1 pass, an inlet joint part 203a and an outlet joint part 203b of the intermediate passage 203, and an inlet connection part 204a and an outlet connection part 204b of the second refrigerant passage 204.

The expansion valve 205 is a solenoid valve driven by a low-voltage battery, and opens the upstream side of the second refrigerant passage 204 to expand the refrigerant.

Next, the assembly work of the multi-way switching valve device M having the above configuration will be described.

As shown in FIG. 5, the base member 100, the cover member 110, the multi-way switching valve 120, the seal member 130, the spacer member 140, the drive unit 150, the water pumps 160 and 170, the reservoir tank 180, the first refrigerant-heat medium heat exchanger 190, the second refrigerant-heat medium heat exchanger 200, the O-rings Sr₁ and Sr₂, and the plurality of screws b1 and b2 are prepared in advance.

First, the seal member 130 and the spacer member 140 are respectively disposed between the pair of projection parts 101b and 101c in the cylindrical recess 101 of the base member 100 from the axis S direction.

Subsequently, the multi-way switching valve 120 with the O-ring Sr₂ attached is inserted into the cylindrical recess 101 from the axis S direction, while the end part 121a is inserted into the bearing recess 101e.

Subsequently, the O-ring Sr₁ is fitted into the annular seal groove 101h of the flange part 101g, and the cover member 110 is joined to the flange part 101g of the base member 100 from the axis S direction and fixed by the screws b2. In this assembled state, the end part 121b of the multi-way switching valve 120 is exposed to the outside through the circular hole 111.

Subsequently, the drive unit 150 is brought close to the cover member 110 from the axis S direction, and is fixed to the cover member 110 by the screws b2 while fitting the end part 121b into the connection hole 155a of the gear 155.

Subsequently, the water pump 160 is fitted into the first pump accommodation recess 102c of the base member 100 from the axis S direction and fixed by the screws b1.

Subsequently, the water pump 170 is fitted into the second pump accommodation recess 104c of the base member 100 from the axis S direction and fixed by the screws b1.

Subsequently, the reservoir tank 180 is joined to the base member 100 from the axis S direction so as to communicate with the branch port 105c and fixed by the screws b1.

Subsequently, the first refrigerant-heat medium heat exchanger 190 is joined to the base member 100 from the axis S direction such that the two disconnection ports 105d and 105e communicate with the intermediate passage 193, and fixed by the screws b1.

Subsequently, the second refrigerant-heat medium heat exchanger 200 is joined to the base member 100 from the axis S direction and is fixed by the screws b1 such that the third downstream end port 106b and the third upstream end port 107b communicate with the intermediate passage 203.

The assembly sequence is not limited to the above procedure, and other procedures may be adopted.

In this way, since various components (the cover member 110, the multi-way switching valve 120, the seal member 130, the spacer member 140, the drive unit 150, the water pumps 160 and 170, the reservoir tank 180, the first refrigerant-heat medium heat exchanger 190, and the second refrigerant-heat medium heat exchanger 200) may be assembled to the base member 100 from one side in the axis S direction, setup during assembly can be reduced, and therefore assembly man-hours can be reduced.

Moreover, by adopting the assembly method from one side in the axis S direction, a plurality of passages (the first inlet side passage 102, the first outlet side passage 103, the second inlet side passage 104, the second outlet side passage 105, the third inlet side passage 106, the third outlet side passage 107, the fourth inlet side passage 108, and the fourth outlet side passage 109) may be disposed radially around the cylindrical recess 101 with respect to the base member 100 and formed integrally, thereby achieving integrated arrangement of the arrangement structure, reduction in the number of components, thinning of the device in the axis S direction, and the like.

Next, the operation of the temperature control system including the multi-way switching valve device M will be described.

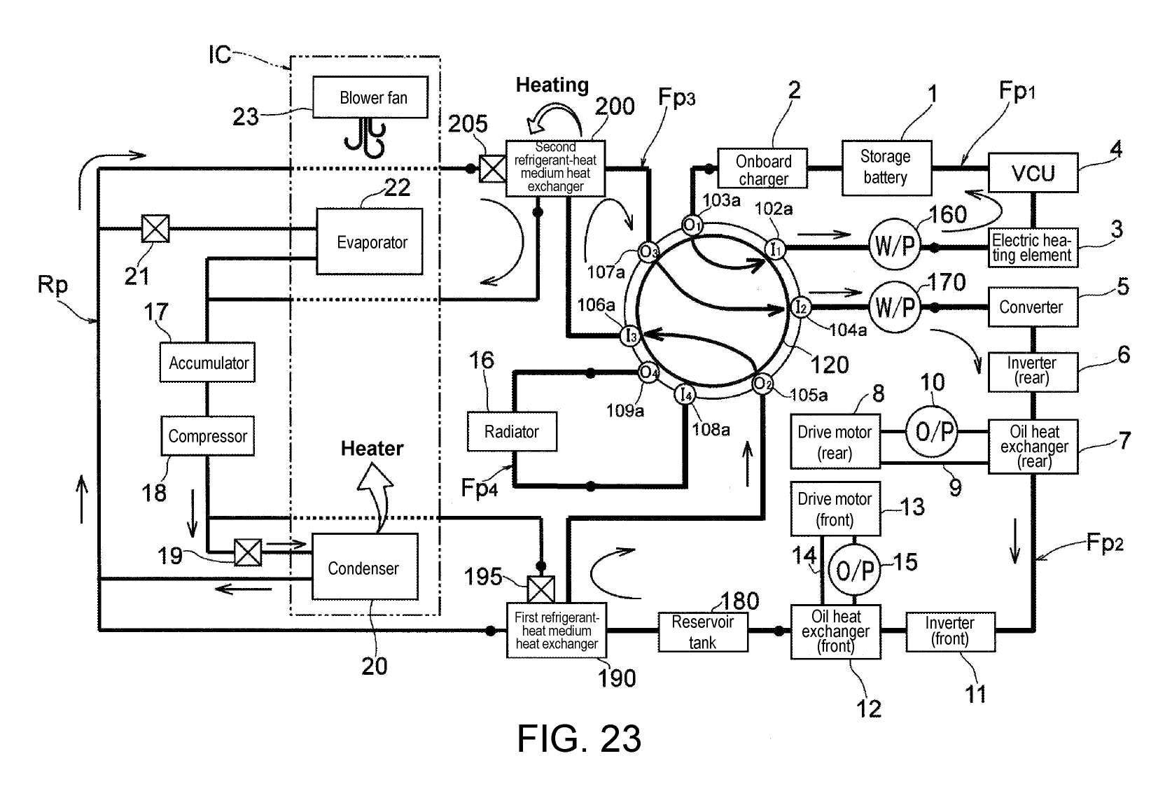

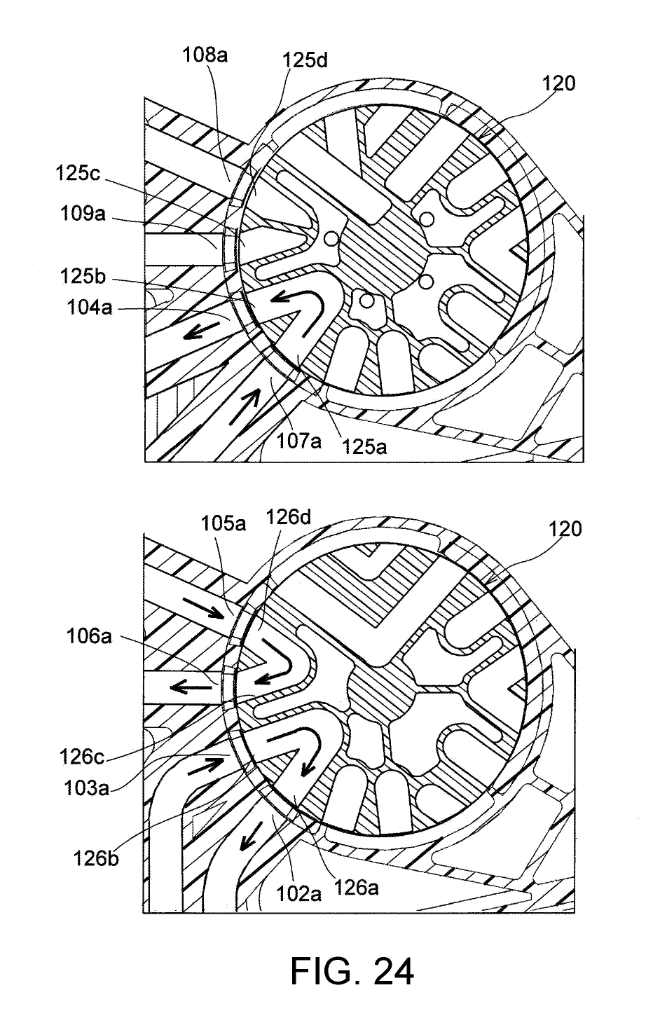

In the case of the multi-way switching valve 120 being located at the first switching position, as shown in FIG. 23 and FIG. 24, the first outlet 103a (outlet O₁) and the first inlet 102a (inlet I₁) are connected to the hollowed-out passage parts 126b and 126a, respectively in an opposing manner, thereby establishing communication between the first outlet side passage 103 and the first inlet side passage 102. The third outlet 107a (outlet O₃) and the second inlet 104a (inlet I₂) are connected to the hollowed-out passage parts 125a and 125b, respectively in an opposing manner, thereby establishing communication between the third outlet side passage 107 and the second inlet side passage 104. The second outlet 105a (outlet O₂) and the third inlet 106a (inlet I₃) are connected to the hollowed-out passage parts 126d and 126c, respectively in an opposing manner, thereby establishing communication between the second outlet side passage 105 and the third inlet side passage 106. The fourth inlet 108a (inlet I₄) and the fourth outlet 109a (outlet O₄) are connected to the hollowed-out passage parts 125d and 125c, respectively in an opposing manner, thereby closing the fourth inlet side passage 108 and the fourth outlet side passage 109.

Therefore, the first heat medium passage Fp₁ forms a closed loop passage, and the second heat medium passage Fp₂ and the third heat medium passage Fp₃ are connected in series to form a closed loop passage. Accordingly, by energizing the electric heating element 3 to generate heat, the cooling water in the first heat medium passage Fp₁ may be heated, and the storage battery 1 may be heated by the heated cooling water.

Moreover, the cooling water heated by the heat generated from the rear drive motor 8 and the front drive motor 13 (and the heat emitted from the converter 5 and the inverters 6 and 11) may be guided to the third heat medium passage Fp₃.

Therefore, as operation mode 1, with the on-off valve 195 and the expansion valve 21 in a closed (OFF) state, the on-off valve 19 is set to an open (ON) state, the compressor 18 is started, and the expansion valve 205 is opened, whereby the refrigerant is heated by the cooling water in the second refrigerant-heat medium heat exchanger 200, while the interior of the cabin IC may be heated by the heat released from the condenser 20. In this operation mode 1, in the case of low outside air temperature, for example, in an environment of -10°C or lower, the storage battery 1 may be heated to an appropriate temperature while suppressing the power consumption of the storage battery 1, and the exhaust heat generated by the drive motor may be recovered to heat the refrigerant, thereby improving the heating efficiency in the cabin IC.

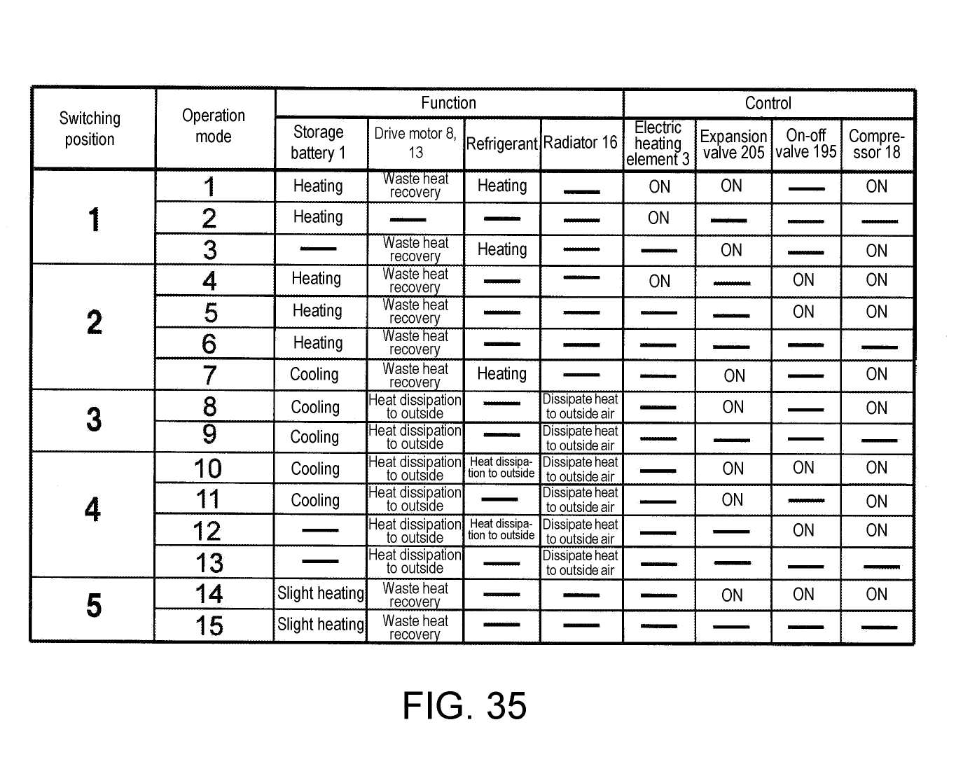

Moreover, at the first switching position, as shown in FIG. 35, operation modes 2 and 3 are set as other operation modes.

In operation mode 2, the electric heating element 3 is turned ON, the on-off valve 195 of the first refrigerant-heat medium heat exchanger 190 is turned OFF, the expansion valve 205 of the second refrigerant-heat medium heat exchanger 200 is turned OFF, and the compressor 18 is turned OFF, thereby heating the storage battery 1.

In operation mode 3, the electric heating element 3 is turned OFF, the expansion valve 205 of the second refrigerant-heat medium heat exchanger 200 is turned ON, and the compressor 18 is turned ON, thereby heating the refrigerant.

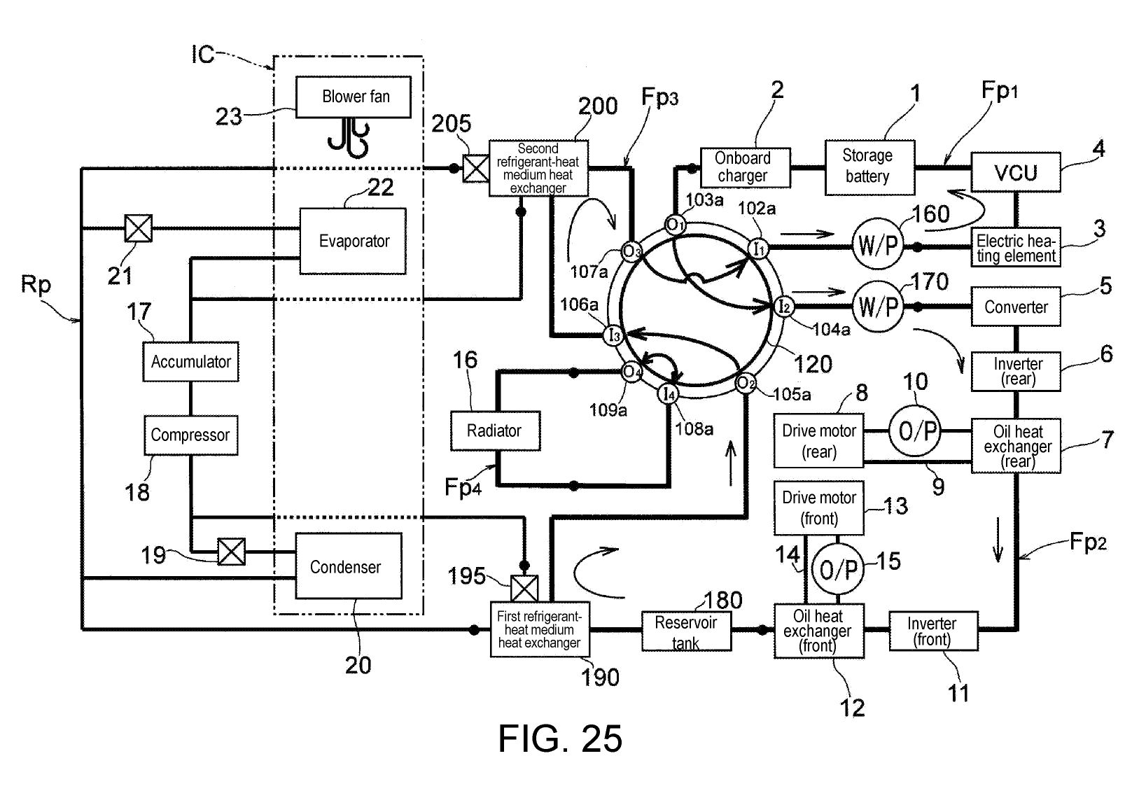

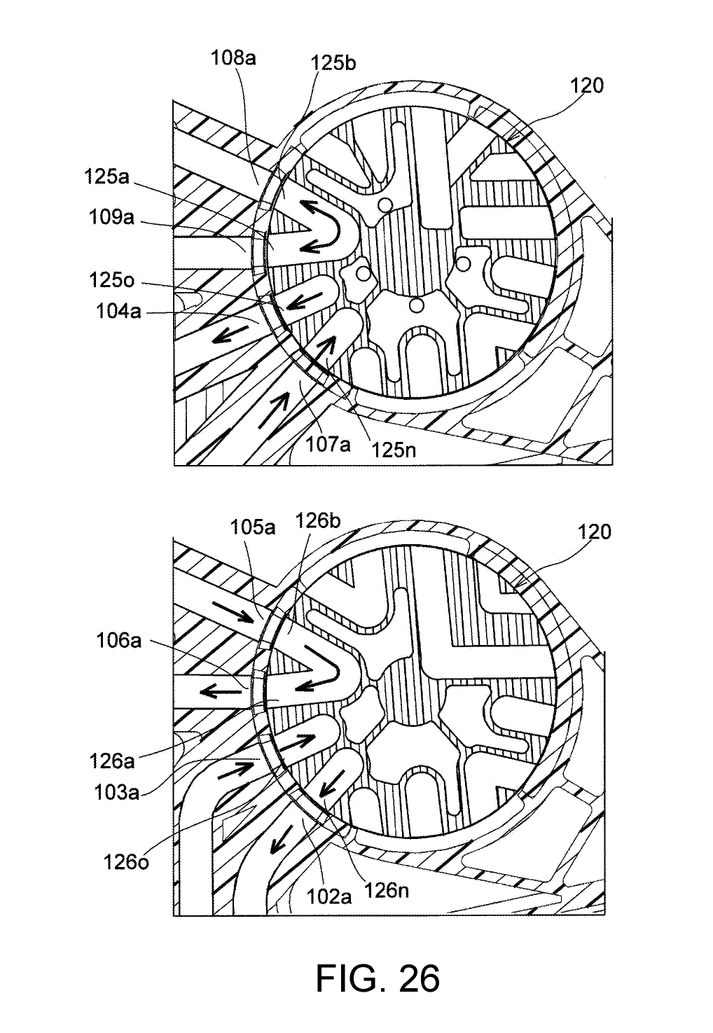

In the case of the multi-way switching valve 120 being located at the second switching position, as shown in FIG. 25 and FIG. 26, the first outlet 103a (outlet O₁) and the second inlet 104a (inlet I₂) are connected to the hollowed-out passage parts 126o and 125o, respectively in an opposing manner, thereby establishing communication between the first outlet side passage 103 and the second inlet side passage 104. The third outlet 107a (outlet O₃) and the first inlet 102a (inlet I₁) are connected to the hollowed-out passage parts 125n and 126n, respectively in an opposing manner, thereby establishing communication between the third outlet side passage 107 and the first inlet side passage 102. The second outlet 105a (outlet O₂) and the third inlet 106a (inlet I₃) are connected to the hollowed-out passage parts 126b and 126a, respectively in an opposing manner, thereby establishing communication between the second outlet side passage 105 and the third inlet side passage 106. The fourth inlet 108a (inlet I₄) and the fourth outlet 109a (outlet O₄) are connected to the hollowed-out passage parts 125b and 125a, respectively in an opposing manner, thereby establishing communication between the fourth inlet side passage 108 and the fourth outlet side passage 109.

Therefore, the first heat medium passage Fp₁, the second heat medium passage Fp₂, and the third heat medium passage Fp₃ are connected in series to form a closed loop passage, and the cooling water circulates through the closed loop passage. Moreover, the fourth heat medium passage Fp₄ forms a closed loop passage by connecting the fourth inlet 108a and the fourth outlet 109a, such that no circulation of cooling water occurs with respect to the radiator 16.

At the second switching position, as shown in FIG. 35, operation modes 4 to 7 are set.

In operation mode 4, the electric heating element 3 is turned ON, the on-off valve 195 of the first refrigerant-heat medium heat exchanger 190 is turned ON, the expansion valve 205 of the second refrigerant-heat medium heat exchanger 200 is turned OFF, and the compressor 18 is turned ON, causing the first refrigerant-heat medium heat exchanger 190 to function as a liquid cooled condenser, and the cooling water is heated by the electric heating element 3 and the refrigerant, thereby heating the storage battery 1.

In operation mode 5, the electric heating element 3 is turned OFF, the on-off valve 195 of the first refrigerant-heat medium heat exchanger 190 is turned ON, the expansion valve 205 of the second refrigerant-heat medium heat exchanger 200 is turned OFF, and the compressor 18 is turned ON, causing the first refrigerant-heat medium heat exchanger 190 to function as a liquid cooled condenser, and the cooling water is heated by the refrigerant, thereby heating the storage battery 1.

In operation mode 6, the electric heating element 3 is turned OFF, the on-off valve 195 of the first refrigerant-heat medium heat exchanger 190 is turned OFF, the expansion valve 205 of the second refrigerant-heat medium heat exchanger 200 is turned OFF, and the compressor 18 is turned OFF. The cooling water is heated only by the heat generated by the heat generating components (the rear drive motor 8, the front drive motor 13, and the like), thereby heating the storage battery 1.

In operation mode 7, the electric heating element 3 is turned OFF, the on-off valve 195 of the first refrigerant-heat medium heat exchanger 190 is turned OFF, the expansion valve 205 of the second refrigerant-heat medium heat exchanger 200 is turned ON, and the compressor 18 is turned ON, causing the second refrigerant-heat medium heat exchanger 200 to function as a chiller to cool the cooling water, thereby cooling the storage battery 1.

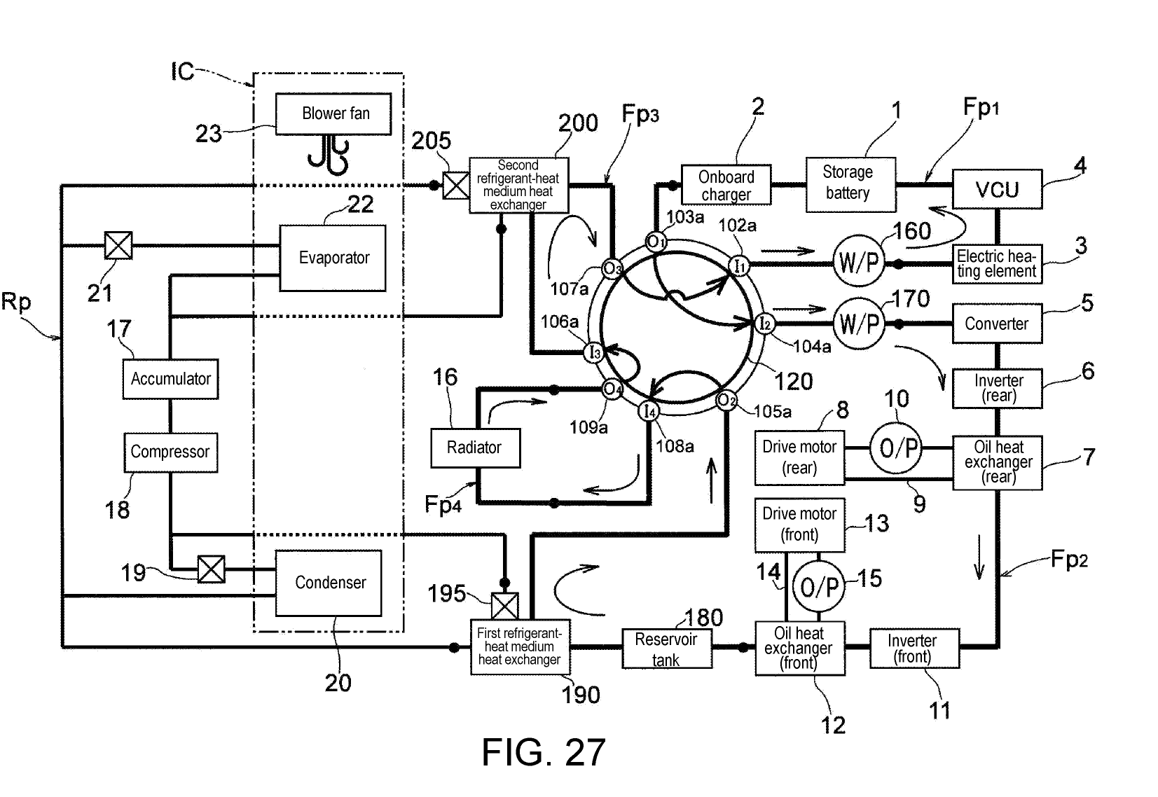

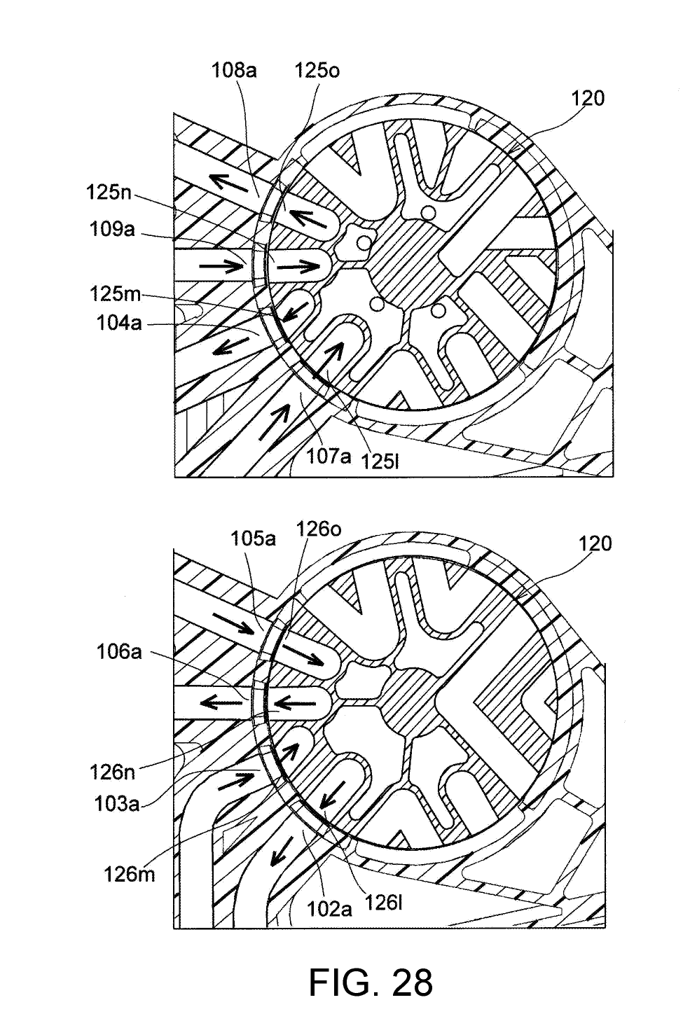

In the case of the multi-way switching valve 120 being located at the third switching position, as shown in FIG. 27 and FIG. 28, the first outlet 103a (outlet O₁) and the second inlet 104a (inlet I₂) are connected to the hollowed-out passage parts 126m and 125m, respectively in an opposing manner, thereby establishing communication between the first outlet side passage 103 and the second inlet side passage 104. The third outlet 107a (outlet O₃) and the first inlet 102a (inlet I₁) are connected to the hollowed-out passage parts 125l and 126l, respectively in an opposing manner, thereby establishing communication between the third outlet side passage 107 and the first inlet side passage 102. The second outlet 105a (outlet O₂) and the fourth inlet 108a (I₄) are connected to the hollowed-out passage parts 126o and 125o, respectively in an opposing manner, thereby establishing communication between the second outlet side passage 105 and the fourth inlet side passage 108. The fourth outlet 109a (outlet O₄) and the third inlet 106a (inlet I₃) are connected to the hollowed-out passage parts 125n and 126n, respectively in an opposing manner, thereby establishing communication between the fourth outlet side passage 109 and the third inlet side passage 106.

Therefore, the first heat medium passage Fp₁, the second heat medium passage Fp₂, the fourth heat medium passage Fp₄, and the third heat medium passage Fp₃ are connected in series to form a closed loop passage, and the cooling water circulates through the closed loop passage.

At the third switching position, as shown in FIG. 35, operation modes 8 and 9 are set.

In operation mode 8, the electric heating element 3 is turned OFF, the on-off valve 195 of the first refrigerant-heat medium heat exchanger 190 is turned OFF, the expansion valve 205 of the second refrigerant-heat medium heat exchanger 200 is turned ON, and the compressor 18 is turned ON, causing the second refrigerant-heat medium heat exchanger 200 to function as a chiller to cool the cooling water, and heat is released to the outside through the radiator 16, thereby cooling the storage battery 1 and the heat generating components (the rear drive motor 8, the front drive motor 13, and the like).

In operation mode 9, the electric heating element 3 is turned OFF, the on-off valve 195 of the first refrigerant-heat medium heat exchanger 190 is turned OFF, the expansion valve 205 of the second refrigerant-heat medium heat exchanger 200 is turned OFF, and the compressor 18 is turned OFF, and heat is released to the outside through the radiator 16, thereby cooling the storage battery 1 and the heat generating components (the rear drive motor 8, the front drive motor 13, and the like).

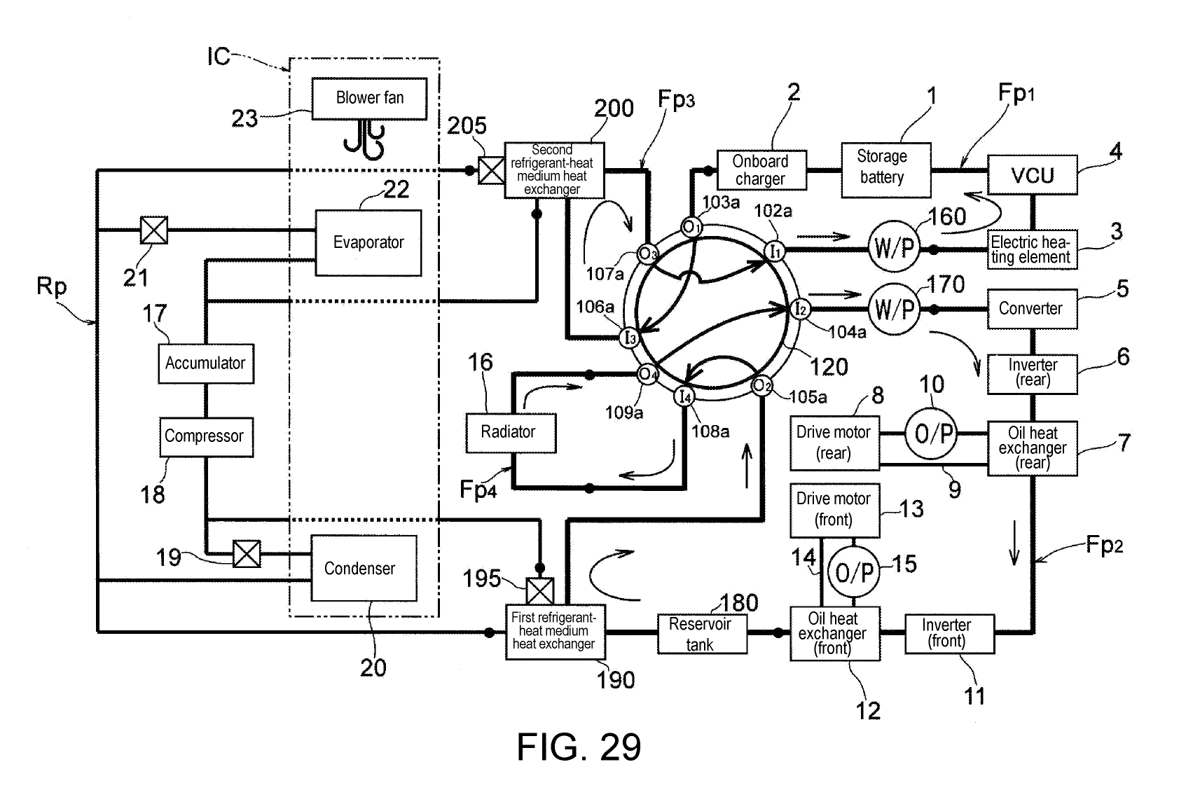

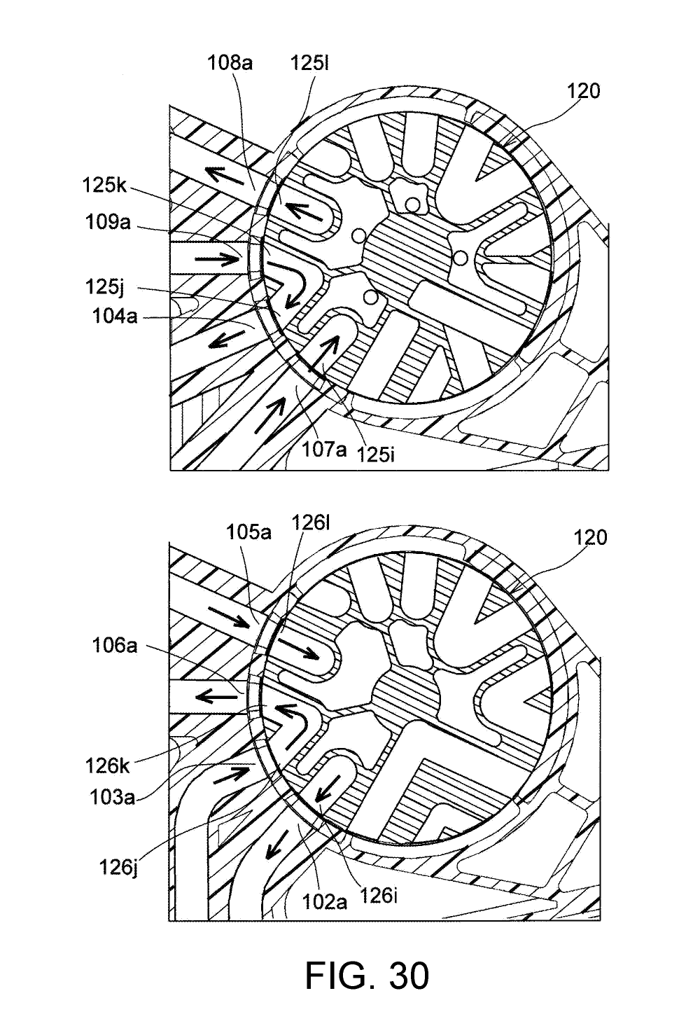

In the case of the multi-way switching valve 120 being located at the fourth switching position, as shown in FIG. 29 and FIG. 30, the first outlet 103a (outlet O₁) and the third inlet 106a (inlet I₃) are connected to the hollowed-out passage parts 126j and 126k, respectively in an opposing manner, thereby establishing communication between the first outlet side passage 103 and the third inlet side passage 106. The third outlet 107a (outlet O₃) and the first inlet 102a (inlet I₁) are connected to the hollowed-out passage parts 125i and 126i, respectively in an opposing manner, thereby establishing communication between the third outlet side passage 107 and the first inlet side passage 102. The second outlet 105a (outlet O₂) and the fourth inlet 108a (inlet I₄) are connected to the hollowed-out passage parts 126l and 125l, respectively in an opposing manner, thereby establishing communication between the second outlet side passage 105 and the fourth inlet side passage 108. The fourth outlet 109a (outlet O₄) and the second inlet 104a (inlet I₂) are connected to the hollowed-out passage parts 125k and 125j, respectively in an opposing manner, thereby establishing communication between the fourth outlet side passage 109 and the second inlet side passage 104.

Therefore, the first heat medium passage Fp₁ and the third heat medium passage Fp₃ are connected in series to form a closed loop passage, and the second heat medium passage Fp₂ and the fourth heat medium passage Fp₄ are connected in series to form a closed loop passage, and the cooling water circulates through each of the closed loop passages.

At the fourth switching position, as shown in FIG. 35, operation modes 10 to 13 are set.

In operation mode 10, the electric heating element 3 is turned OFF, the on-off valve 195 of the first refrigerant-heat medium heat exchanger 190 is turned ON, the expansion valve 205 of the second refrigerant-heat medium heat exchanger 200 is turned ON, and the compressor 18 is turned ON, causing the first refrigerant-heat medium heat exchanger 190 to function as a liquid cooled condenser to release heat from the refrigerant to the cooling water, and the second refrigerant-heat medium heat exchanger 200 to function as a chiller to cool the cooling water, and heat is released to the outside through the radiator 16, thereby cooling the storage battery 1 and the heat generating components (the rear drive motor 8, the front drive motor 13, and the like).

In operation mode 11, the electric heating element 3 is turned OFF, the on-off valve 195 of the first refrigerant-heat medium heat exchanger 190 is turned OFF, the expansion valve 205 of the second refrigerant-heat medium heat exchanger 200 is turned ON, and the compressor 18 is turned ON, causing the second refrigerant-heat medium heat exchanger 200 to function as a chiller to cool the cooling water, and heat is released to the outside through the radiator 16, thereby cooling the storage battery 1 and the heat generating components (the rear drive motor 8, the front drive motor 13, and the like).

In operation mode 12, the electric heating element 3 is turned OFF, the on-off valve 195 of the first refrigerant-heat medium heat exchanger 190 is turned ON, the expansion valve 205 of the second refrigerant-heat medium heat exchanger 200 is turned OFF, and the compressor 18 is turned ON, causing the first refrigerant-heat medium heat exchanger 190 to function as a liquid cooled condenser to release heat from the refrigerant to the cooling water, and heat is released to the outside through the radiator 16, thereby cooling the heat generating components (the rear drive motor 8, the front drive motor 13, and the like).

In operation mode 13, the electric heating element 3 is turned OFF, the on-off valve 195 of the first refrigerant-heat medium heat exchanger 190 is turned OFF, the expansion valve 205 of the second refrigerant-heat medium heat exchanger 200 is turned OFF, and the compressor 18 is turned OFF, and heat is released to the outside through the radiator 16, thereby cooling the heat generating components (the rear drive motor 8, the front drive motor 13, and the like).

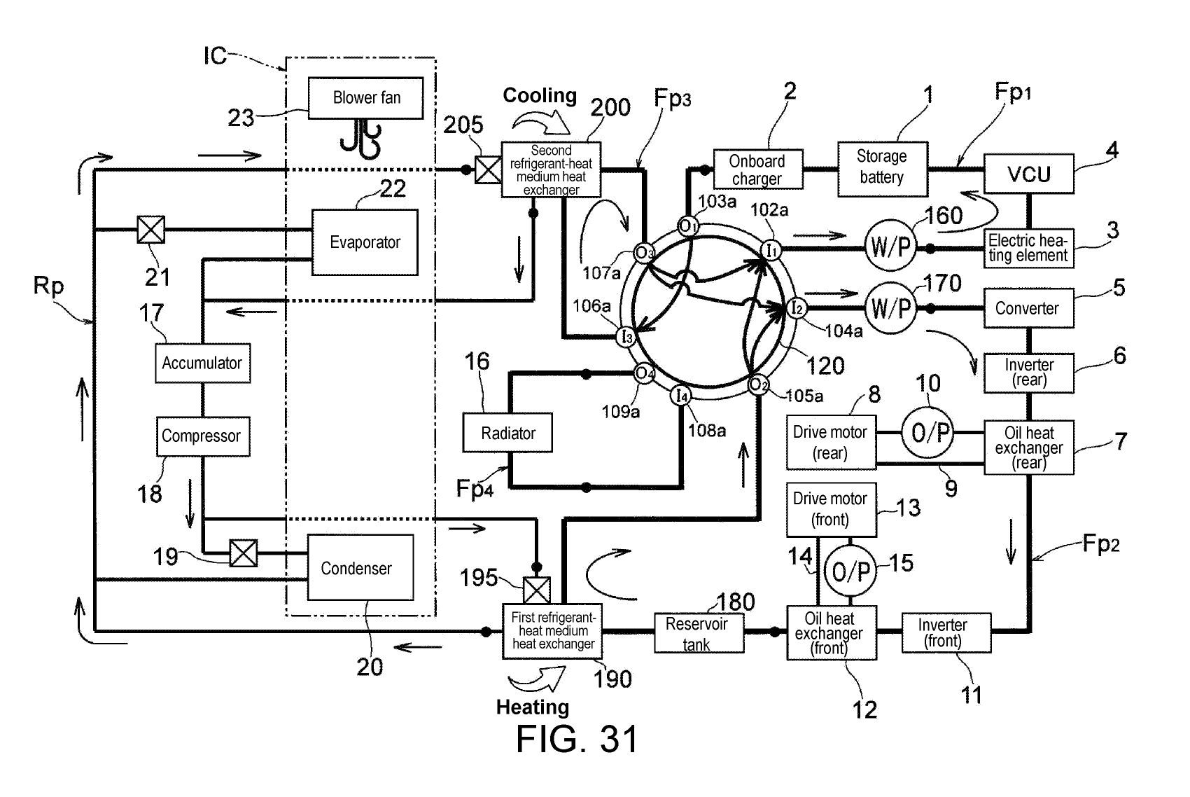

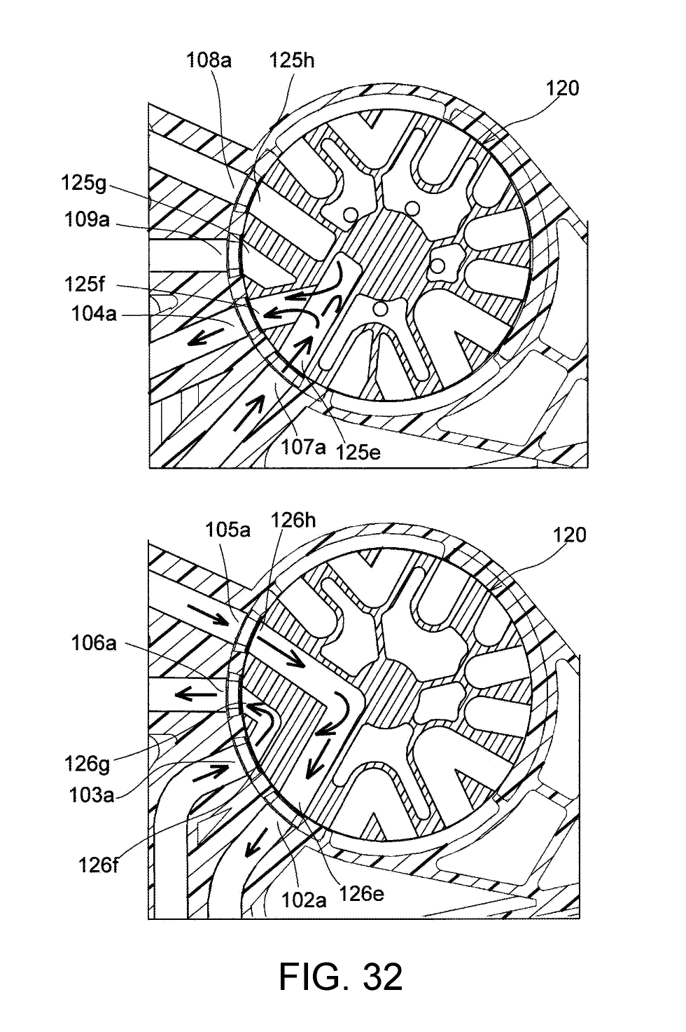

In the case of the multi-way switching valve 120 being located at the fifth switching position as a mixed switching position for mixing cooling water as fluids having different state quantities (here, temperatures), as shown in FIG. 31 and FIG. 32, the first outlet 103a (outlet O₁) and the third inlet 106a (inlet I₃) are connected to the hollowed-out passage parts 126f and 126g, respectively in an opposing manner, thereby establishing communication between the first outlet side passage 103 and the third inlet side passage 106. The third outlet 107a (outlet O₃) and the first inlet 102a (inlet I₁) and the second inlet 104a (inlet I₂) are connected to the hollowed-out passage parts 125e and 126e, and 125f, respectively in an opposing manner, thereby establishing communication between the third outlet side passage 107 and the first inlet side passage 102 and the second inlet side passage 104. The second outlet 105a (outlet O₂) and the first inlet 102a (inlet I₁) and the second inlet 104a (inlet I₂) are connected to the hollowed-out passage parts 126h and 126e, and 125f, respectively in an opposing manner, thereby establishing communication between the second outlet side passage 105 and the first inlet side passage 102 and the second inlet side passage 104. The fourth inlet 108a (inlet I₄) and the fourth outlet 109a (outlet O₄) are connected to the hollowed-out passage parts 125h and 125g, respectively in an opposing manner, thereby closing the fourth inlet side passage 108 and the fourth outlet side passage 109.

Therefore, the first heat medium passage Fp₁ and the third heat medium passage Fp₃ are connected in series to form a closed loop passage, the first heat medium passage Fp₁, the third heat medium passage Fp₃, and the second heat medium passage Fp₂ are connected in series to form a closed loop passage, and the second heat medium passage Fp₂ forms a closed loop passage that circulates through itself, and the cooling water circulates through each closed loop passage.

At the fifth switching position, as shown in FIG. 35, operation modes 14 and 15 are set.

In operation mode 14, the electric heating element 3 is turned OFF, the on-off valve 195 of the first refrigerant-heat medium heat exchanger 190 is turned ON, the expansion valve 205 of the second refrigerant-heat medium heat exchanger 200 is turned ON, and the compressor 18 is turned ON, causing the first refrigerant-heat medium heat exchanger 190 to function as a liquid cooled condenser to release heat from the refrigerant to the cooling water, and the second refrigerant-heat medium heat exchanger 200 to function as a chiller to cool the cooling water, thereby moderately heating (slightly heating) the storage battery 1. In this way, by appropriately heating and cooling the cooling water, it is possible to prevent the temperature of the storage battery 1 from becoming unstable, and maintain the storage battery 1 at an appropriate management temperature.

In operation mode 15, the electric heating element 3 is turned OFF, the on-off valve 195 of the first refrigerant-heat medium heat exchanger 190 is turned OFF, the expansion valve 205 of the second refrigerant-heat medium heat exchanger 200 is turned OFF, and the compressor 18 is turned OFF, and the cooling water is heated by heat recovered from heat-generating components (the rear drive motor 8, the front drive motor 13, and the like), thereby moderately heating (slightly heating) the storage battery 1.

In this way, for example, while suppressing the heat generation by the electric heating element 3, heat (exhaust heat) generated from the heat-generating components (the converter 5, the inverters 6 and 11, the rear drive motor 8, and the front drive motor 13) may be utilized to adjust the cooling water in the first heat medium passage Fp₁ to an optimal temperature, thereby heating (slightly heating) the storage battery 1 to an appropriate temperature.

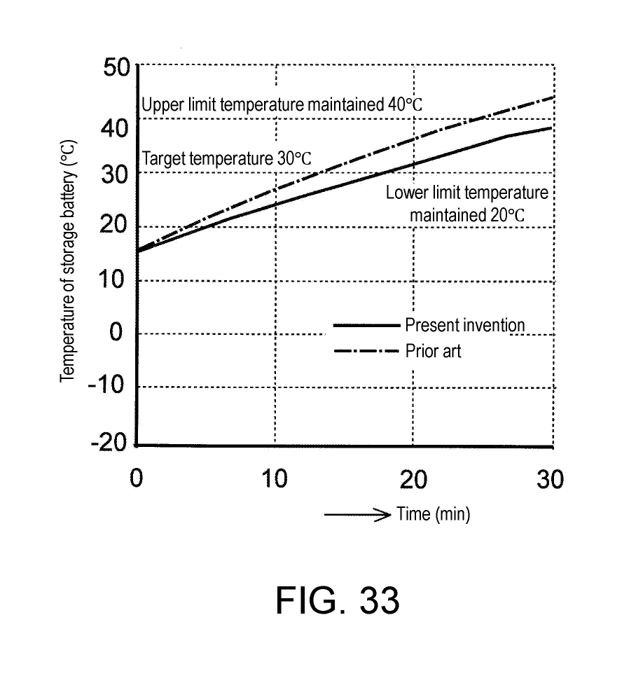

FIG. 33 shows simulation results comparing the stabilization of the temperature of the storage battery 1 between the disclosure and the prior art when the management temperature (target reaching temperature) of the storage battery 1 is set to 30°C, that is, comparing the length of time during which the temperature can be maintained within a predetermined range centered on the target temperature. As may be seen from FIG. 33, the disclosure can maintain the temperature in the target temperature range for a longer time compared to the prior art, and accordingly, stabilization of the temperature of the storage battery 1 can be achieved.

If the heat generation of the electric heating element 3 is increased, the time for the storage battery 1 to reach an appropriate temperature becomes shorter, but overshoot exceeding the allowable upper limit temperature occurs, the switching frequency to the cooling mode increases, and there is a possibility of causing complication of control and destabilization of the storage battery 1. Therefore, by mixing and flowing cooling water having different state quantities (temperatures) as described above, the cooling water may be adjusted to an optimal temperature for the storage battery 1, overshoot as in conventional cases can be avoided, the switching frequency can be reduced, and the storage battery 1 can be maintained at a stable temperature.

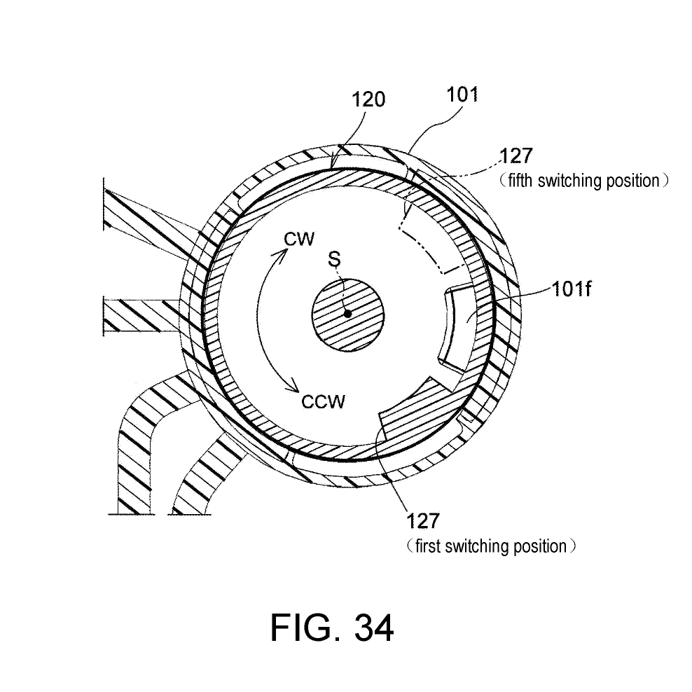

As described above, the multi-way switching valve 120 is appropriately switched from the first switching position to the fifth switching position. As shown in FIG. 34, the position of the contact part 127 indicated by the solid line corresponds to the first switching position, and when rotated in one direction (clockwise CW), the valve passes through the second switching position, the third switching position, and the fourth switching position to reach the fifth switching position, which is the position of the contact part 127 indicated by the two-dot chain line. In this manner, the multi-way switching valve 120 is positioned at a desired switching position while the angular position is detected by the Hall IC 156, by rotating clockwise (CW) or counterclockwise (CCW) as appropriate with the stopper 101f as a boundary.

As described above, the multi-way switching valve device of the disclosure includes a base member 100 defining the first inlet 102a and the first outlet 103a of a first fluid passage; a second inlet 104a and a second outlet 105a of a second fluid passage; a third inlet 106a and a third outlet 107a of a third fluid passage, and a fourth inlet 108a and a fourth outlet 109a of a fourth fluid passage; and a multi-way switching valve 120 rotatably disposed on the base member 100 and performing switching operation among a plurality of switching positions to open and close the first inlet 102a to the fourth inlet 108a and the first outlet 103a to the fourth outlet 109a. The multi-way switching valve 120, at a mixed switching position included in the plurality of switching positions, causes fluid flowing out from the first outlet 103a to flow into the first inlet 102a and the second inlet 104a, and causes fluid flowing out from the second outlet 105a to flow into the second inlet 104a and the first inlet 102a.

According to this, in the first fluid passage, the fluid flowing therethrough may be circulated and the fluid flowing through the second fluid passage may be introduced to form a mixed flow, and in the second fluid passage, the fluid flowing therethrough may be circulated and the fluid flowing through the first fluid passage may be introduced to form a mixed flow. Therefore, in the case where the state quantities (for example, temperatures) of the respective fluids are different, each may be adjusted to an appropriate temperature.

Further, the multi-way switching valve 120, at the mixed switching position, connects the first outlet 103a to the third inlet 106a, connects the third outlet 107a to the first inlet 102a and the second inlet 104a, connects the second outlet 105a to the first inlet 102a and the second inlet 104a, and closes the fourth inlet 108a and the fourth outlet 109a.

According to this, the fluid flowing out from the first fluid passage may be returned to the first fluid passage via the third fluid passage and may also be made into flow to the second fluid passage, and the fluid flowing out from the second fluid passage may be returned to the second fluid passage and may also be made to flow into the first fluid passage. Therefore, in the case where the fluid flowing through the third fluid passage is heated or cooled from outside, for example, the fluid in a state corresponding thereto may be directed to the first fluid passage and the second fluid passage.

Further, the plurality of switching positions include a first switching position, a second switching position, a third switching position, a fourth switching position, and a fifth switching position that are sequentially switched upon rotation of the multi-way switching valve 120 in one direction, and the fifth switching position is the mixed switching position.

According to this, by the multi-way switching valve 120 rotating in one direction, switching operation from the first switching position to the fifth switching position may be performed, and conversely, by rotating in the other direction, switching operation from the fifth switching position to the first switching position may be performed.

Further, the multi-way switching valve 120, at the first switching position, connects the first outlet 103a to the first inlet 102a, connects the third outlet 107a to the second inlet 104a, connects the second outlet 105a to the third inlet 106a, and closes the fourth inlet 108a and the fourth outlet 109a.

According to this, the first fluid passage may be formed as a closed loop passage, the second fluid passage and the third fluid passage may be connected in series to form a closed loop passage, and the fluid may be circulated in each of the closed loop passages.

Further, the multi-way switching valve 120, at the second switching position, connects the first outlet 103a to the second inlet 104a, connects the third outlet 107a to the first inlet 102a, connects the second outlet 105a to the third inlet 106a, and connects the fourth inlet 108a to the fourth outlet 109a, at the third switching position, connects the first outlet 103a to the second inlet 104a, connects the third outlet 107a to the first inlet 102a, connects the second outlet 105a to the fourth inlet 108a, and connects the fourth outlet 109a to the third inlet 106a, and at the fourth switching position, connects the first outlet 103a to the third inlet 106a, connects the third outlet 107a to the first inlet 102a, connects the second outlet 105a to the fourth inlet 108a, and connects the fourth outlet 109a to the second inlet 104a.

According to this, the first fluid passage, the second fluid passage, and the third fluid passage may be connected in series to form a closed loop passage, and the fluid may be circulated in the closed loop passage, while the fourth fluid passage may be formed as a closed pool passage.

Further, the base member 100 includes a cylindrical recess 101 that rotatably accommodates the multi-way switching valve 120 around a predetermined axis S, and the cylindrical recess 101 includes a first inner circumferential surface 101a₁ and the second inner circumferential surface 101a₂ divided in the direction of the axis S, four openings O₃, I₂, O₄, I₄ disposed in the circumferential direction on the first inner circumferential surface 101a₁, and four openings I₁, O₁, I₃, O₂ disposed in the circumferential direction on the second inner circumferential surface 101a₂. The multi-way switching valve 120 forms a cylindrical shape rotatably disposed in the cylindrical recess 101 around the axis S, and includes fifteen hollowed-out passage parts 125a to 125o disposed and opening on the first outer circumferential surface 120a₁ corresponding to the first inner circumferential surface 101a₁, and fifteen hollowed-out passage parts 126a to 126o disposed and opening on the second outer circumferential surface 120a₂ corresponding to the second inner circumferential surface 101a₂, in order to form the operating state at the first switching position to the fifth switching position.

According to this, instead of using a plurality of switching valves, by using one multi-way switching valve 120, it is possible to obtain a function of performing five switching operations from the first switching position to the fifth switching position while achieving miniaturization thereof.

Further, the four openings O₃, I₂, O₄, I₄ disposed on the first inner circumferential surface 101a₁ correspond to the third outlet 107a, the second inlet 104a, the fourth outlet 109a, and the fourth inlet 108a, and the four openings I₁, O₁, I₃, O₂ disposed on the second inner circumferential surface 101a₂ correspond to the first inlet 102a, the first outlet 103a, the third inlet 106a, and the second outlet 105a.

According to this, by arranging a plurality of openings in a two-stage configuration on the inner circumferential surface 101a of the cylindrical recess 101, the first fluid passage to the fourth fluid passage may be disposed correspondingly, and thinning, miniaturization, reduction in the number of parts, and the like of the base member 100 can be achieved.

Further, the multi-way switching valve 120 includes a vertical groove passage part Vg that communicates the hollowed-out passage part 125e of the first outer circumferential surface 120a₁ and the hollowed-out passage part 126e of the second outer circumferential surface 120a₂ disposed in the direction of the axis S, and the hollowed-out passage part 125f of the first outer circumferential surface 120a₁ and the hollowed-out passage part 126h of the second outer circumferential surface 120a₂ formed to communicate with the vertical groove passage part Vg, in order to connect the third outlet 107a to the first inlet 102a and the second inlet 104a, and to connect the second outlet 105a to the first inlet 102a and the second inlet 104a.

According to this, in one multi-way switching valve 120, it is possible to obtain a function of mixing fluids flowing through a plurality of passages and flowing the mixed flow to the downstream side.

Further, the multi-way switching valve 120 includes a rotating shaft 121 centered on the axis S, the first hollowed-out part 122 and a second hollowed-out part 123 hollowed out from both sides in the direction of the axis S around the rotating shaft 121, and the communication hole 124a that communicates the first hollowed-out part 122 and the second hollowed-out part 123.

According to this, when molding the multi-way switching valve 120, weight reduction can be achieved, and by providing the communication hole 124a, it may be used as an air vent hole for discharging air and the like mixed in the fluid.

Further, the first fluid passage is a first heat medium passage Fp₁ through which a heat medium that performs heat exchange with the storage battery 1 flows, the second fluid passage is a second heat medium passage Fp₂ through which a heat medium that performs heat exchange with the drive motors 8 and 13 that drive the wheels flows, the third fluid passage is a third heat medium passage Fp₃ through which a heat medium that performs heat exchange with the refrigerant circulating through the refrigerant passage Rp flows, and the fourth fluid passage is a fourth heat medium passage Fp₄ through which a heat medium that performs heat exchange with the outside air via the radiator 16 flows.

According to this, through the first heat medium passage Fp₁, the second heat medium passage Fp₂, the third heat medium passage Fp₃, and the fourth heat medium passage Fp₄, the temperature of the heat medium (cooling water) may be appropriately adjusted to a suitable temperature.

Further, the base member 100 includes a first inlet side passage 102 and a first outlet side passage 103 forming a part of the first heat medium passage Fp₁, the second inlet side passage 104 and a second outlet side passage 105 forming a part of the second heat medium passage Fp₂, a third inlet side passage 106 and a third outlet side passage 107 forming a part of the third heat medium passage Fp₃, and a fourth inlet side passage 108 and a fourth outlet side passage 109 forming a part of the fourth heat medium passage Fp₄.

According to this, by providing passages forming a part of the first heat medium passage Fp₁ to the fourth heat medium passage Fp₄ included in the temperature control system in the base member 100, simplification of the system, reduction of the number of parts, and the like can be achieved.

Further, in the base member 100, a first electric pump (water pump 160) that pressure-feeds the heat medium is disposed in the first inlet side passage 102.

According to this, in the first inlet side passage 102, the heat medium can be forcibly pressure-fed.

Further, in the base member 100, a second electric pump (water pump 170) that pressure-feeds the heat medium is disposed in the second inlet side passage 104.

According to this, in the second inlet side passage 104, the heat medium can be forcibly pressure-fed.

Further, in the base member 100, a reservoir tank 180 through which the heat medium passes is disposed in the second outlet side passage 105.

According to this, the internal pressure of the second heat medium passage Fp₂ that fluctuates according to the temperature change of the heat medium (cooling water) may be adjusted, and damage to parts due to excessive pressure and the like can be prevented.

Further, in the base member 100, a first refrigerant-heat medium heat exchanger 190 that performs heat exchange between the refrigerant and the heat medium is disposed on the downstream side of the reservoir tank 180 in the second outlet side passage 105.

According to this, heat exchange may be performed between the heat medium flowing through the second outlet side passage 105 and the refrigerant flowing through the refrigerant passage RP via the first refrigerant-heat medium heat exchanger 190, and for example, the first refrigerant-heat medium heat exchanger 190 may function as a liquid cooled condenser to heat the heat medium.

Further, the first refrigerant-heat medium heat exchanger 190 includes a heat exchange part 192, an intermediate passage 193 forming a part of the second heat medium passage Fp₂, and a first refrigerant passage 194 forming a part of the refrigerant passage Rp, and the on-off valve 195 is disposed on the upstream side of the first refrigerant passage 194.

According to this, the heat exchange between the refrigerant and the heat medium may be appropriately adjusted by the opening and closing operation of the on-off valve 195.

Further, in the base member 100, a second refrigerant-heat medium heat exchanger 200 that performs heat exchange between the refrigerant and the heat medium is disposed between the third inlet side passage 106 and the third outlet side passage 107.

According to this, heat exchange may be performed between the heat medium flowing through the third heat medium passage (the third inlet side passage 106 and the third outlet side passage 107) and the refrigerant flowing through the refrigerant passage Rp via the second refrigerant-heat medium heat exchanger 200, and for example, the second refrigerant-heat medium heat exchanger 200 may function as a chiller to cool the heat medium.

Further, the second refrigerant-heat medium heat exchanger 200 includes a heat exchange part 202, an intermediate passage 203 connecting the third inlet side passage 106 and the third outlet side passage 107, and a second refrigerant passage 204 forming a part of the refrigerant passage Rp, and the expansion valve 205 is disposed on the upstream side of the second refrigerant passage 204.

According to this, the heat exchange between the refrigerant and the heat medium may be appropriately adjusted by the opening and closing operation of the expansion valve 205.

In the above embodiment, a case is shown in which the multi-way switching valve device is configured to adjust the flow of the heat medium (cooling water) as the target fluid, however, the disclosure is not limited to this, and the multi-way switching valve device may also be configured to adjust the flow of other fluids.

In the above embodiment, as the mixed switching position (fifth switching position) of the multi-way switching valve 120, a configuration via the third fluid passage (third heat medium passage Fp₃) is shown, however, the disclosure is not limited to this, and a configuration may be adopted that includes a mixed switching position in which the fluid flowing out from the first outlet of the first fluid passage is directly returned to the first inlet of the first fluid passage and guided to the second inlet of the second fluid passage to mix the fluid, and the fluid flowing out from the second outlet of the second fluid passage is returned to the second inlet of the second fluid passage and guided to the first inlet of the first fluid passage to mix the fluid.

In the above embodiment, a configuration is shown in which the first electric pump (water pump 160) is disposed in the first inlet side passage 102 of the first heat medium passage Fp₁, however, the disclosure is not limited to this, and a configuration that does not adopt the first electric pump may be used as long as the passage and structure are such that natural circulation occurs due to the temperature gradient of the heat medium.

In the above embodiment, a configuration is shown in which the second electric pump (water pump 170) is disposed in the second inlet side passage 104 of the second heat medium passage Fp₂, however, the disclosure is not limited to this, and a configuration that does not adopt the second electric pump may be used as long as the passage and structure are such that natural circulation occurs due to the temperature gradient of the heat medium.

As described above, the multi-way switching valve device of the disclosure may mix fluids having different state quantities (for example, temperature), and can achieve miniaturization, simplification as a system, reduction in the number of parts, and the like, and therefore is useful not only for application to electric vehicles and the like, but also for systems in other fields or other equipment.

What is claimed is:

1. A multi-way switching valve device, comprising:
a base member defining a first inlet and a first outlet of a first fluid passage, a second inlet and a second outlet of a second fluid passage, a third inlet and a third outlet of a third fluid passage, and a fourth inlet and a fourth outlet of a fourth fluid passage; and
a multi-way switching valve rotatably disposed on the base member and performing switching operation among a plurality of switching positions to open and close the first to the fourth inlets and the first to the fourth outlets,
wherein the multi-way switching valve, at a mixed switching position included in the plurality of switching positions, causes fluid flowing out from the first outlet to flow into the first inlet and the second inlet, and causes fluid flowing out from the second outlet to flow into the second inlet and the first inlet.

2. The multi-way switching valve device according to claim 1,
wherein the multi-way switching valve, at the mixed switching position, connects the first outlet to the third inlet, connects the third outlet to the first inlet and the second inlet, connects the second outlet to the first inlet and the second inlet, and closes the fourth inlet and the fourth outlet.

3. The multi-way switching valve device according to claim 2,
wherein the plurality of switching positions comprise a first switching position, a second switching position, a third switching position, a fourth switching position, and a fifth switching position that are sequentially switched upon rotation of the multi-way switching valve in one direction, and
wherein the fifth switching position is the mixed switching position.

4. The multi-way switching valve device according to claim 3,
wherein the multi-way switching valve, at the first switching position, connects the first outlet to the first inlet, connects the third outlet to the second inlet, connects the second outlet to the third inlet, and closes the fourth inlet and the fourth outlet.

5. The multi-way switching valve device according to claim 4,
wherein the multi-way switching valve,
at the second switching position, connects the first outlet to the second inlet, connects the third outlet to the first inlet, connects the second outlet to the third inlet, and connects the fourth inlet to the fourth outlet;
at the third switching position, connects the first outlet to the second inlet, connects the third outlet to the first inlet, connects the second outlet to the fourth inlet, and connects the fourth outlet to the third inlet; and
at the fourth switching position, connects the first outlet to the third inlet, connects the third outlet to the first inlet, connects the second outlet to the fourth inlet, and connects the fourth outlet to the second inlet.

6. The multi-way switching valve device according to claim 5,
wherein the base member comprises a cylindrical recess that rotatably accommodates the multi-way switching valve around a predetermined axis;
the cylindrical recess comprises a first inner circumferential surface and a second inner circumferential surface divided in a direction of the axis, four openings disposed in a circumferential direction on the first inner circumferential surface, and four openings disposed in a circumferential direction on the second inner circumferential surface; and
the multi-way switching valve has a cylindrical shape rotatably disposed in the cylindrical recess around the axis, and comprises fifteen hollowed-out passage parts disposed and opening on a first outer circumferential surface corresponding to the first inner circumferential surface and fifteen hollowed-out passage parts disposed and opening on a second outer circumferential surface corresponding to the second inner circumferential surface, to form operating states at the first to fifth switching positions.

7. The multi-way switching valve device according to claim 6,
wherein the four openings disposed on the first inner circumferential surface correspond to the third outlet, the second inlet, the fourth outlet, and the fourth inlet; and
the four openings disposed on the second inner circumferential surface correspond to the first inlet, the first outlet, the third inlet, and the second outlet.

8. The multi-way switching valve device according to claim 7,
wherein the multi-way switching valve comprises a vertical groove passage part that provides communication between the hollowed-out passage part of the first outer circumferential surface and the hollowed-out passage part of the second outer circumferential surface disposed in the direction of the axis so as to connect the third outlet to the first inlet and the second inlet and to connect the second outlet to the first inlet and the second inlet; and the hollowed-out passage part of the first outer circumferential surface and the hollowed-out passage part of the second outer circumferential surface formed to communicate with the vertical groove passage part.

9. The multi-way switching valve device according to claim 8,
wherein the multi-way switching valve comprises a rotating shaft centered on the axis, a first hollowed-out part and a second hollowed-out part hollowed out from both sides in the direction of the axis around the rotating shaft, and a communication hole that provides communication between the first hollowed-out part and the second hollowed-out part.

10. The multi-way switching valve device according to claim 1,
wherein the first fluid passage is a first heat medium passage through which a heat medium that performs heat exchange with a storage battery flows;
the second fluid passage is a second heat medium passage through which a heat medium that performs heat exchange with a drive motor that drives wheels flows;
the third fluid passage is a third heat medium passage through which a heat medium that performs heat exchange with a refrigerant circulating through a refrigerant passage flows; and
the fourth fluid passage is a fourth heat medium passage through which a heat medium that performs heat exchange with outside air via a radiator flows.

11. The multi-way switching valve device according to claim 10,
wherein the base member comprises a first inlet side passage and a first outlet side passage that form a part of the first heat medium passage, a second inlet side passage and a second outlet side passage that form a part of the second heat medium passage, a third inlet side passage and a third outlet side passage that form a part of the third heat medium passage, and a fourth inlet side passage and a fourth outlet side passage that form a part of the fourth heat medium passage.

12. The multi-way switching valve device according to claim 11,
wherein in the base member, a first electric pump that pressure-feeds the heat medium is disposed in the first inlet side passage.

13. The multi-way switching valve device according to claim 11,
wherein in the base member, a second electric pump that pressure-feeds the heat medium is disposed in the second inlet side passage.

14. The multi-way switching valve device according to claim 11,
wherein in the base member, a reservoir tank through which the heat medium passes is disposed in the second outlet side passage.

15. The multi-way switching valve device according to claim 14,
wherein in the base member, a first refrigerant-heat medium heat exchanger that performs heat exchange between the refrigerant and the heat medium is disposed on a downstream side of the reservoir tank in the second outlet side passage.

16. The multi-way switching valve device according to claim 15,
wherein the first refrigerant-heat medium heat exchanger comprises a heat exchange part, an intermediate passage forming a part of the second heat medium passage, and a first refrigerant passage forming a part of the refrigerant passage; and
an on-off valve is disposed on an upstream side of the first refrigerant passage.

17. The multi-way switching valve device according to claim 11,
wherein in the base member, a second refrigerant-heat medium heat exchanger that performs heat exchange between the refrigerant and the heat medium is disposed between the third inlet side passage and the third outlet side passage.

18. The multi-way switching valve device according to claim 17,
wherein the second refrigerant-heat medium heat exchanger comprises a heat exchange part, an intermediate passage connecting the third inlet side passage and the third outlet side passage, and a second refrigerant passage forming a part of the refrigerant passage; and
an expansion valve is disposed on an upstream side of the second refrigerant passage.
